(19) United States
(12) Patent Application Publication
(10) Pub. No.: US 2017/0060998 A1
(43) Pub. Date: Mar. 2, 2017

(54) METHOD AND APPARATUS FOR MINING MAXIMAL REPEATED SEQUENCE

(71) Applicant: Huawei Technologies Co., Ltd., Shenzhen (CN)

(72) Inventors: Chen Liang, Shenzhen (CN); Wei Fan, Shenzhen (CN)

(21) Appl. No.: 15/349,580

(22) Filed: Nov. 11, 2016

Related U.S. Application Data
(63) Continuation of application No. PCT/CN2014/089726, filed on Oct. 28, 2014.

(30) Foreign Application Priority Data
May 13, 2014 (CN) 201410200896.8

(51) Int. Cl. G06F 17/30

(52) U.S. Cl. CPC G06F 17/30684; G06F 17/30625

(57) ABSTRACT

The present invention provide a method and an apparatus for mining a maximal repeated sequence, where a maximal repeated sequence is determined based on pipelines and a suffix tree, thereby implementing incremental mining and improving computation efficiency. The method comprises: acquiring a character; appending the character to each pipeline in a pipeline set, and separately determining whether a sequence in each pipeline appended with the character is the same as a corresponding sequence on a suffix tree; determining a maximal repeated sequence according to a first preset policy and the sequence in the first pipeline when there exists such a first pipeline in the pipeline set that after the character is appended to the first pipeline, a sequence in the first pipeline is different from a corresponding sequence on the suffix tree.

### CROSS-REFERENCE TO RELATED APPLICATIONS

This application is a continuation of International Application No. PCT/CN2014/089726, filed on Oct. 28, 2014, which claims priority to Chinese Patent Application No. 201410200896.8, filed on May 13, 2014. The disclosures of the aforementioned applications are hereby incorporated by reference in their entireties.

### TECHNICAL FIELD

The present invention relates to the field of data mining, and in particular, to a method and an apparatus for mining a maximal repeated sequence.

### BACKGROUND

Pattern mining refers to searching a group of sequence data for some particular basic sequence patterns that are easy to be understood and interpreted by people, to decompose processed long sequence data, thereby facilitating various modeling and re-analysis in later stages, reducing a degree of human intervention in large data traffic, and improving the efficiency and accuracy of sequence processing. Therefore, pattern mining plays an extremely important role in a software-controlled device. For example, pattern mining is widely applied to many fields, such as user behavior modeling, sensor data flow analysis, financial system fraud transaction recognition, and biological gene sequence detection, of a smart phone. In an actual application of pattern mining, people usually use a maximal repeated sequence in sequence data as a basic sequence pattern. The maximal repeated sequence is a sequence pattern that includes most information and that is made into a smallest structure. However, in pattern mining, there is such a type of data that as time goes by, new data is generated continuously. For example, a sensor carried in a mobile phone device may record a location, a call, an Internet browsing record, and the like of a user every moment, and this type of data is sequenced in chronological order and presented in a serialized manner. Especially, with vigorous development of big data and the Internet, a generation quantity and speed of the sequence data grow exponentially, and how to dynamically mine a basic sequence pattern (that is, a maximal repeated sequence) from the sequence data in real time has become an urgent problem to be resolved.

At present, a method for mining a maximal repeated sequence in sequence data is: establishing a corresponding suffix tree according to sequence data in a period of time, and then searching for a maximal repeated sequence in suffixes, where the suffix tree is a data structure that can resolve a lot of problems related to character strings, and is used to support valid character matching and query. For example, sequence data “abcabxa$” is expressed by using a suffix tree shown in FIG. 1, that is, a path from a root node of the suffix tree to each leaf node represents each suffix sub-sequence of “abcabxa$”; then, searching for and marking two leaf nodes that have different left elements; traversing each node on the suffix tree in a bottom-up manner starting from the leaf node, where a node whose sub-tree has a marked node is also marked; if a sub-tree of a node does not have a marked node, checking left elements of child nodes of the node; if the left elements of the child nodes of the node are different, marking the current node; and scanning all nodes by using this method until the root node is scanned, and eliminating all nodes that are not marked, where the rest of the tree is a maximal repeated sequence. It can be learned that, in the prior art, traversing and marking need to be performed on an entire suffix tree, to determine a maximal repeated sequence, and when new data is added to original sequence data the next moment, apart from adding a corresponding node structure to the original suffix tree according to an establishment rule of the suffix tree, statistical collection and identification also need to be performed on a previous traversing and marking result again, that is, traversing and marking need to be performed again on the suffix tree to which a node is added, which increases a computation amount.

### SUMMARY

Embodiments of the present invention provide a method and an apparatus for mining a maximal repeated sequence, where a maximal repeated sequence is determined based on pipelines and a suffix tree, thereby implementing incremental mining and improving computation efficiency.

To achieve the foregoing objective, the following technical solutions are used in the present invention:

According to a first aspect, an embodiment of the present invention provides a method for mining a maximal repeated sequence, including:

acquiring a character;

appending the character to each pipeline in a pipeline set, and separately determining whether a sequence in each pipeline appended with the character is the same as a corresponding sequence on a suffix tree, where the pipeline set includes at least one pipeline, the pipeline includes a sequence and a location pointer, the sequence includes a character the same as a character that is in a character string in which the character is located and that is in front of the character, and the location pointer points to a location, on the suffix tree, of a tail character of the sequence included in the pipeline; and

in the pipeline set, if there exists such a first pipeline that after the character is appended to the first pipeline, a sequence in the first pipeline is different from a corresponding sequence on the suffix tree, determining a maximal repeated sequence according to a first preset policy and the sequence in the first pipeline.

In a first possible implementation manner of the first aspect, with reference to the first aspect, the determining a maximal repeated sequence according to a first preset policy and the sequence in the first pipeline includes:

detecting, in the character string, whether left characters adjacent to sequences that are the same as the sequence in the first pipeline are characters of a same type, and detecting whether right characters adjacent to the sequences that are the same as the sequence in the first pipeline are characters of a same type; and

if the left characters adjacent to the sequences that are the same as the sequence in the first pipeline are not characters of a same type, and the right characters adjacent to the sequences that are the same as the sequence in the first pipeline are not characters of a same type, determining that the sequence in the first pipeline is the maximal repeated sub-sequence; or if the left characters adjacent to the sequences that are the same as the sequence in the first pipeline are characters of a same type, or the right characters adjacent to the sequences that are the same as the sequence in the first pipeline are characters of a same type, or the left characters adjacent to the sequences that are the same as the sequence in the first pipeline are characters of a same type and the right characters adjacent to the sequences that are the same as the sequence in the first pipeline are characters of a same type, determining that the sequence in the first pipeline is not the maximal repeated sequence, and destroying the first pipeline.

In a second possible implementation manner of the first aspect, with reference to the first possible implementation manner of the first aspect, the detecting, in the character string, whether left characters adjacent to sequences that are the same as the sequence in the first pipeline are characters of a same type, and detecting whether right characters adjacent to the sequences that are the same as the sequence in the first pipeline are characters of a same type includes:

acquiring, in the character string, a set of left characters adjacent to the sequences that are the same as the sequence in the first pipeline; if the character set includes characters of a same type, determining that the left characters adjacent to the sequences that are the same as the sequence in the first pipeline are characters of a same type; or if the character set includes at least two types of characters, determining that the left characters adjacent to the sequences that are the same as the sequence in the first pipeline are not characters of a same type; and

on the suffix tree, determining whether a character to which a location pointer of the first pipeline points is the same as the character, if the character to which the location pointer of the first pipeline points is the same as the character, determining that the right characters adjacent to the sequences that are the same as the sequence in the first pipeline are characters of a same type, or if the character to which the location pointer of the first pipeline points is different from the character, determining that the right characters adjacent to the sequences that are the same as the sequence in the first pipeline are not characters of a same type.

In a third possible implementation manner of the first aspect, with reference to any implementation manner of the first aspect to the second possible implementation manner of the first aspect, the separately determining whether a sequence in each pipeline appended with the character is the same as a corresponding sequence on a suffix tree includes:

on the suffix tree, separately moving the location pointer in each pipeline, so that the location pointer points to a location of a next character adjacent to the tail character of the sequence included in the pipeline; and

determining whether the character to which the moved location pointer points is the same as the character; if the character to which the moved location pointer points is different from the character, determining that the sequence in the pipeline appended with the character is different from the corresponding sequence on the suffix tree; or if the character to which the moved location pointer points is the same as the character, determining that the sequence in the pipeline appended with the character is the same as the corresponding sequence on the suffix tree.

In a fourth possible implementation manner of the first aspect, with reference to the first aspect, the method further includes:

in the pipeline set, if there exists such a second pipeline that after the character is appended to the second pipeline, a sequence in the second pipeline is the same as a corresponding sequence on the suffix tree, appending the character to the second pipeline, and pointing a location pointer of the second pipeline to a location, on the suffix tree, of a tail character of the sequence included in the second pipeline appended with the character; and

determining a maximal non-concatenated repeated sequence according to the location pointer of the second pipeline and a second preset policy.

In a fifth possible implementation manner of the first aspect, with reference to the fourth possible implementation manner of the first aspect, the determining a maximal non-concatenated repeated sequence according to the location pointer of the second pipeline and a second preset policy includes:

determining whether the location pointer of the second pipeline is the same as a location pointer of a reference pipeline of the second pipeline, where the reference pipeline of the second pipeline is a pipeline that is in the pipeline set and that includes a sequence whose initial character is the same as an initial character of the sequence included in the second pipeline when the initial character of the sequence included in the second pipeline is read; and

if the location pointer of the second pipeline is the same as the location pointer of the reference pipeline of the second pipeline, determining that the sequence in the second pipeline is the maximal non-concatenated repeated sequence.

In a sixth possible implementation manner of the first aspect, with reference to the fifth possible implementation manner of the first aspect, the method further includes:

determining that the sequence in the reference pipeline of the second pipeline is a concatenated sequence that includes the sequence in the second pipeline, and destroying the second pipeline and the reference pipeline of the second pipeline.

In a seventh possible implementation manner of the first aspect, with reference to any implementation manner of the first aspect to the sixth possible implementation manner of the first aspect, before the character is read, an empty pipeline is established; and

correspondingly, the method further includes:

traversing an initial character of each branch of the suffix tree;

if an initial character the same as the character exists, storing the character into the empty pipeline, and pointing a location pointer of the empty pipeline to a location, on the suffix tree, of the initial character the same as the character; and in the pipeline set, if there exists such a third pipeline that after the character is appended to the third pipeline, a sequence in the third pipeline is different from a corresponding sequence on the suffix tree, splitting, starting from a location to which a location pointer of the third pipeline points, a corresponding branch on the suffix tree into two branches, and inserting the character into each branch on the suffix tree after splitting; or if there exists such a third pipeline that after the character is appended to the third pipeline, a sequence in the third pipeline is the same as a corresponding sequence on the suffix tree, inserting the character into each branch on the suffix tree; or

if an initial character the same as the character does not exist, destroying the empty pipeline, and splitting a new branch from a root node of the suffix tree; and in the pipeline set, if there exists such a third pipeline that after the character is appended to the third pipeline, a sequence in the third pipeline is different from a corresponding sequence on the suffix tree, splitting, starting from a location to which a location pointer of the third pipeline points, a corresponding branch on the suffix tree into two branches, and inserting the character into each branch of the suffix tree after splitting; or if there exists such a third pipeline that after the character is appended to the third pipeline, a sequence in the third pipeline is the same as a corresponding sequence on the suffix tree, inserting the character into each branch of the suffix tree after splitting.

In an eighth possible implementation manner of the first aspect, with reference to any implementation manner of the first aspect to the seventh possible implementation manner of the first aspect, the method further includes:

storing related information of the determined maximal repeated sequence and related information of the determined maximal non-concatenated repeated sequence into a preset pattern information table, and expressing, on the suffix tree, the related information of the maximal repeated sequence and the related information of the maximal non-concatenated repeated sequence, where the related information includes: a sequence number, sequence content, and a sequence length.

According to a second aspect, an embodiment of the present invention provides an apparatus for mining a maximal repeated sequence, including:

an acquiring module, configured to acquire a character;

a judging module, configured to: append the character acquired by the acquiring module to each pipeline in a pipeline set, and separately determine whether a sequence in each pipeline appended with the character is the same as a corresponding sequence on a suffix tree, where the pipeline set includes at least one pipeline, the pipeline includes a sequence and a location pointer, the sequence includes a character the same as a character that is in a character string in which the character is located and that is in front of the character, and the location pointer points to a location, on the suffix tree, of a tail character of the sequence included in the pipeline; and

a first determining module, configured to: in the pipeline set, if there exists such a first pipeline that after the character is appended to the first pipeline, a sequence in the first pipeline is different from a corresponding sequence on the suffix tree, determine a maximal repeated sequence according to a first preset policy and the sequence in the first pipeline.

In a first possible implementation manner of the second aspect, with reference to the second aspect, the first determining module is specifically configured to:

detect, in the character string, whether left characters adjacent to sequences that are the same as the sequence in the first pipeline are characters of a same type, and detect whether right characters adjacent to the sequences that are the same as the sequence in the first pipeline are characters of a same type; and

if the left characters adjacent to the sequences that are the same as the sequence in the first pipeline are not characters of a same type, and the right characters adjacent to the sequences that are the same as the sequence in the first pipeline are not characters of a same type, determine that the sequence in the first pipeline is the maximal repeated sub-sequence; or if the left characters adjacent to the sequences that are the same as the sequence in the first pipeline are characters of a same type, or the right characters adjacent to the sequences that are the same as the sequence in the first pipeline are characters of a same type, or the left characters adjacent to the sequences that are the same as the sequence in the first pipeline are characters of a same type and the right characters adjacent to the sequences that are the same as the sequence in the first pipeline are characters of a same type, determine that the sequence in the first pipeline is not the maximal repeated sequence, and destroy the first pipeline.

In a second possible implementation manner of the second aspect, with reference to the first possible implementation manner of the second aspect, the first determining module is specifically configured to:

acquire, in the character string, a set of left characters adjacent to the sequences that are the same as the sequence in the first pipeline; if the character set includes characters of a same type, determine that the left characters adjacent to the sequences that are the same as the sequence in the first pipeline are characters of a same type; or if the character set includes at least two types of characters, determine that the left characters adjacent to the sequences that are the same as the sequence in the first pipeline are not characters of a same type; and

on the suffix tree, determine whether a character to which a location pointer of the first pipeline points is the same as the character, if the character to which the location pointer of the first pipeline points is the same as the character, determine that the right characters adjacent to the sequences that are the same as the sequence in the first pipeline are characters of a same type, or if the character to which the location pointer of the first pipeline points is different from the character, determine that the right characters adjacent to the sequences that are the same as the sequence in the first pipeline are not characters of a same type.

In a third possible implementation manner of the second aspect, with reference to any implementation manner of the second aspect to the second possible implementation manner of the second aspect, the judging module is specifically configured to:

on the suffix tree, separately move the location pointer in each pipeline, so that the location pointer points to a location of a next character adjacent to the tail character of the sequence included in the pipeline; and

determine whether the character to which the moved location pointer points is the same as the character; if the character to which the moved location pointer points is different from the character, determine that the sequence in the pipeline appended with the character is different from the corresponding sequence on the suffix tree; or if the character to which the moved location pointer points is the same as the character, determine that the sequence in the pipeline appended with the character is the same as the corresponding sequence on the suffix tree.

In a fourth possible implementation manner of the second aspect, with reference to the second aspect, the apparatus further includes:

an appending module, configured to: in the pipeline set, if there exists such a second pipeline that after the character is appended to the second pipeline, a sequence in the second pipeline is the same as a corresponding sequence on the suffix tree, append the character to the second pipeline, and point a location pointer of the second pipeline to a location, on the suffix tree, of a tail character of the sequence included in the second pipeline appended with the character; and

a second determining module, configured to determine a maximal non-concatenated repeated sequence according to the location pointer of the second pipeline and a second preset policy.

In a fifth possible implementation manner of the second aspect, with reference to the fourth possible implementation manner of the second aspect, the second determining module is specifically configured to:

determine whether the location pointer of the second pipeline is the same as a location pointer of a reference pipeline of the second pipeline, where the reference pipeline of the second pipeline is a pipeline that is in the pipeline set and that includes a sequence whose initial character is the same as an initial character of the sequence included in the second pipeline when the initial character of the sequence included in the second pipeline is read; and

if the location pointer of the second pipeline is the same as the location pointer of the reference pipeline of the second pipeline, determine that the sequence in the second pipeline is the maximal non-concatenated repeated sequence.

In a sixth possible implementation manner of the second aspect, with reference to the fifth possible implementation manner of the second aspect, the apparatus further includes:

a destruction module, configured to: determine that the sequence in the reference pipeline of the second pipeline is a concatenated sequence that includes the sequence in the second pipeline, and destroy the second pipeline and the reference pipeline of the second pipeline.

In a seventh possible implementation manner of the second aspect, with reference to any implementation manner of the second aspect to the sixth possible implementation manner of the second aspect, the apparatus further includes:

an establishment module, configured to establish an empty pipeline before the acquiring module acquires the character; and

a search module, configured to traverse an initial character of each branch of the suffix tree;

a storage module, configured to: if an initial character the same as the character exists, store the character into the empty pipeline, and point a location pointer of the empty pipeline to a location, on the suffix tree, of the initial character the same as the character; and in the pipeline set, if there exists such a third pipeline that after the character is appended to the third pipeline, a sequence in the third pipeline is different from a corresponding sequence on the suffix tree, split, starting from a location to which a location pointer of the third pipeline points, a corresponding branch on the suffix tree into two branches, and insert the character into each branch on the suffix tree after splitting; or if there exists such a third pipeline that after the character is appended to the third pipeline, a sequence in the third pipeline is the same as a corresponding sequence on the suffix tree, insert the character into each branch on the suffix tree; or

if an initial character the same as the character does not exist, destroy the empty pipeline, and split a new branch from a root node of the suffix tree; and in the pipeline set, if there exists such a third pipeline that after the character is appended to the third pipeline, a sequence in the third pipeline is different from a corresponding sequence on the suffix tree, split, starting from a location to which a location pointer of the third pipeline points, a corresponding branch on the suffix tree into two branches, and insert the character into each branch of the suffix tree after splitting; or if there exists such a third pipeline that after the character is appended to the third pipeline, a sequence in the third pipeline is the same as a corresponding sequence on the suffix tree, insert the character into each branch of the suffix tree after splitting.

In an eighth possible implementation manner of the second aspect, with reference to any implementation manner of the second aspect to the seventh possible implementation manner of the second aspect, the apparatus further includes:

a pattern information storage module, configured to store related information of the determined maximal repeated sequence and related information of the determined maximal non-concatenated repeated sequence into a preset pattern information table, and express, on the suffix tree, the related information of the maximal repeated sequence and the related information of the maximal non-concatenated repeated sequence, where the related information includes: a sequence number, sequence content, and a sequence length.

According to a third aspect, an embodiment of the present invention provides an apparatus for mining a maximal repeated sequence, including:

a communications unit, configured to acquire a character; and

a processor, configured to: append the character acquired by the communications unit to each pipeline in a pipeline set, and separately determine whether a sequence in each pipeline appended with the character is the same as a corresponding sequence on a suffix tree, where the pipeline set includes at least one pipeline, the pipeline includes a sequence and a location pointer, the sequence includes a character the same as a character that is in a character string in which the character is located and that is in front of the character, and the location pointer points to a location, on the suffix tree, of a tail character of the sequence included in the pipeline; and

in the pipeline set, if there exists such a first pipeline that after the character is appended to the first pipeline, a sequence in the first pipeline is different from a corresponding sequence on the suffix tree, determine a maximal repeated sequence according to a first preset policy and the sequence in the first pipeline.

In a first possible implementation manner of the third aspect, with reference to the third aspect, the processor is specifically configured to:

detect, in the character string, whether left characters adjacent to sequences that are the same as the sequence in the first pipeline are characters of a same type, and detect whether right characters adjacent to the sequences that are the same as the sequence in the first pipeline are characters of a same type; and

if the left characters adjacent to the sequences that are the same as the sequence in the first pipeline are not characters of a same type, and the right characters adjacent to the sequences that are the same as the sequence in the first pipeline are not characters of a same type, determine that the sequence in the first pipeline is the maximal repeated sub-sequence; or if the left characters adjacent to the sequences that are the same as the sequence in the first pipeline are characters of a same type, or the right characters adjacent to the sequences that are the same as the sequence in the first pipeline are characters of a same type, or the left characters adjacent to the sequences that are the same as the sequence in the first pipeline are characters of a same type and the right characters adjacent to the sequences that are the same as the sequence in the first pipeline are characters of a same type, determine that the sequence in the first pipeline is not the maximal repeated sequence, and destroy the first pipeline.

In a second possible implementation manner of the third aspect, with reference to the first possible implementation manner of the third aspect, the processor is further configured to:

acquire, in the character string, a set of left characters adjacent to the sequences that are the same as the sequence in the first pipeline; if the character set includes characters of a same type, determine that the left characters adjacent to the sequences that are the same as the sequence in the first pipeline are characters of a same type; or if the character set includes at least two types of characters, determine that the left characters adjacent to the sequences that are the same as the sequence in the first pipeline are not characters of a same type; and

on the suffix tree, determine whether a character to which a location pointer of the first pipeline points is the same as the character, if the character to which the location pointer of the first pipeline points is the same as the character, determine that the right characters adjacent to the sequences that are the same as the sequence in the first pipeline are characters of a same type, or if the character to which the location pointer of the first pipeline points is different from the character, determine that the right characters adjacent to the sequences that are the same as the sequence in the first pipeline are not characters of a same type.

In a third possible implementation manner of the third aspect, with reference to any implementation manner of the third aspect to the second possible implementation manner of the third aspect, the processor is further configured to:

on the suffix tree, separately move the location pointer in each pipeline, so that the location pointer points to a location of a next character adjacent to the tail character of the sequence included in the pipeline; and

determine whether the character to which the moved location pointer points is the same as the character; if the character to which the moved location pointer points is different from the character, determine that the sequence in the pipeline appended with the character is different from the corresponding sequence on the suffix tree; or if the character to which the moved location pointer points is the same as the character, determine that the sequence in the pipeline appended with the character is the same as the corresponding sequence on the suffix tree.

In a fourth possible implementation manner of the third aspect, with reference to the third aspect, the processor is further configured to:

in the pipeline set, if there exists such a second pipeline that after the character is appended to the second pipeline, a sequence in the second pipeline is the same as a corresponding sequence on the suffix tree, append the character to the second pipeline, and point a location pointer of the second pipeline to a location, on the suffix tree, of a tail character of the sequence included in the second pipeline appended with the character; and

determine a maximal non-concatenated repeated sequence according to the location pointer of the second pipeline and a second preset policy.

In a fifth possible implementation manner of the third aspect, with reference to the fourth possible implementation manner of the third aspect, the processor is further configured to:

determine whether the location pointer of the second pipeline is the same as a location pointer of a reference pipeline of the second pipeline, where the reference pipeline of the second pipeline is a pipeline that is in the pipeline set and that includes a sequence whose initial character is the same as an initial character of the sequence included in the second pipeline when the initial character of the sequence included in the second pipeline is read; and

if the location pointer of the second pipeline is the same as the location pointer of the reference pipeline of the second pipeline, determine that the sequence in the second pipeline is the maximal non-concatenated repeated sequence.

In a sixth possible implementation manner of the third aspect, with reference to the fifth possible implementation manner of the third aspect, the processor is further configured to:

determine that the sequence in the reference pipeline of the second pipeline is a concatenated sequence that includes the sequence in the second pipeline, and destroy the second pipeline and the reference pipeline of the second pipeline.

In a seventh possible implementation manner of the third aspect, with reference to any implementation manner of the third aspect to the sixth possible implementation manner of the third aspect, the processor is further configured to:

establish an empty pipeline before the communications unit acquires the character;

traverse an initial character of each branch of the suffix tree;

if an initial character the same as the character exists, store the character into the empty pipeline, and point a location pointer of the empty pipeline to a location, on the suffix tree, of the initial character the same as the character; and in the pipeline set, if there exists such a third pipeline that after the character is appended to the third pipeline, a sequence in the third pipeline is different from a corresponding sequence on the suffix tree, split, starting from a location to which a location pointer of the third pipeline points, a corresponding branch on the suffix tree into two branches, and insert the character into each branch on the suffix tree after splitting; or if there exists such a third pipeline that after the character is appended to the third pipeline, a sequence in the third pipeline is the same as a corresponding sequence on the suffix tree, insert the character into each branch on the suffix tree; or

if an initial character the same as the character does not exist, destroy the empty pipeline, and split a new branch from a root node of the suffix tree; and in the pipeline set, if there exists such a third pipeline that after the character is appended to the third pipeline, a sequence in the third pipeline is different from a corresponding sequence on the suffix tree, split, starting from a location to which a location pointer of the third pipeline points, a corresponding branch on the suffix tree into two branches, and insert the character into each branch of the suffix tree after splitting; or if there exists such a third pipeline that after the character is appended to the third pipeline, a sequence in the third pipeline is the same as a corresponding sequence on the suffix tree, insert the character into each branch of the suffix tree after splitting.

In an eighth possible implementation manner of the third aspect, with reference to any implementation manner of the third aspect to the seventh possible implementation manner of the third aspect, the processor is further configured to:

store related information of the determined maximal repeated sequence and related information of the determined maximal non-concatenated repeated sequence into a preset pattern information table, and express, on the suffix tree, the related information of the maximal repeated sequence and the related information of the maximal non-concatenated repeated sequence, where the related information includes: a sequence number, sequence content, and a sequence length.

It can be learned from the above that, the embodiments of the present invention provide a method and an apparatus for mining a maximal repeated sequence, where a character is acquired; the character is appended to each pipeline in a pipeline set, and it is separately determined whether a sequence in each pipeline appended with the character is the same as a corresponding sequence on a suffix tree, where the pipeline set includes at least one pipeline, the pipeline includes a sequence and a location pointer, the sequence includes a character the same as a character that is in a character string in which the character is located and that is in front of the character, and the location pointer points to a location, on the suffix tree, of a tail character of the sequence included in the pipeline; and in the pipeline set, if there exists such a first pipeline that after the character is appended to the first pipeline, a sequence in the first pipeline is different from a corresponding sequence on the suffix tree, a maximal repeated sequence is determined according to a first preset policy and the sequence in the first pipeline. In this way, a maximal repeated sequence is mined by means of a combination of a pipeline structure and a suffix tree structure, which improves a computation rate. Besides, in the pipeline set, if there exists such a second pipeline that after the character is appended to the second pipeline, a sequence in the second pipeline is the same as a corresponding sequence on the suffix tree, the character is appended to the second pipeline, and a location pointer of the second pipeline is pointed to a location, on the suffix tree, of a tail character of the sequence included in the second pipeline appended with the character; and a maximal non-concatenated repeated sequence is determined according to the location pointer of the second pipeline and a second preset policy, so that the mined maximal repeated sequence is a non-concatenated repeated sequence, which avoids problems in the prior art that incremental mining cannot be implemented, a computation amount is large, and a mined maximal repeated sequence includes a redundant concatenated structure and cannot effectively express a minimal unit of a sequence pattern.

### BRIEF DESCRIPTION OF THE DRAWINGS

To describe the technical solutions in the embodiments of the present invention or in the prior art more clearly, the following briefly describes the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a schematic flowchart of mining a maximal repeated sequence in the prior art;

FIG. 2 is a flowchart of a method for mining a maximal repeated sequence according to an embodiment of the present invention;

FIG. 3 is a schematic flowchart of mining a maximal repeated sequence in a character string “abcabx” according to an embodiment of the present invention;

FIG. 4 is a schematic flowchart of mining a maximal non-concatenated repeated sequence in a character string “abcababab” according to an embodiment of the present invention;

FIG. 5 is a schematic diagram of sequence pattern information expressed on a suffix tree according to an embodiment of the present invention;

FIG. 6 is a structural diagram of an apparatus 60 for mining a maximal repeated sequence according to an embodiment of the present invention;

FIG. 7 is a structural diagram of an apparatus 60 for mining a maximal repeated sequence according to an embodiment of the present invention;

FIG. 8 is a structural diagram of an apparatus 60 for mining a maximal repeated sequence according to an embodiment of the present invention;

FIG. 9 is a structural diagram of an apparatus 60 for mining a maximal repeated sequence according to an embodiment of the present invention;

FIG. 10 is a structural diagram of an apparatus 60 for mining a maximal repeated sequence according to an embodiment of the present invention; and

FIG. 11 is a structural diagram of an apparatus 110 for mining a maximal repeated sequence according to an embodiment of the present invention.

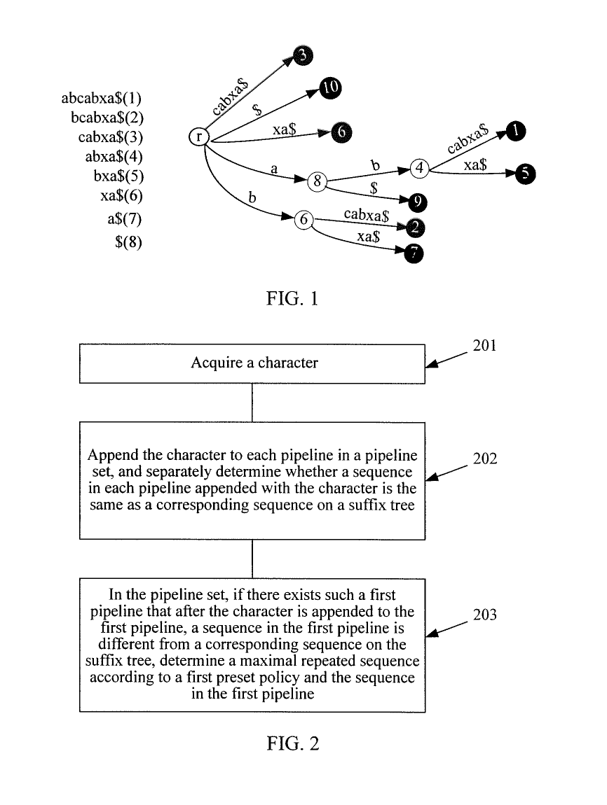

### DETAILED DESCRIPTION

The following clearly describes the technical solutions in the embodiments of the present invention with reference to the accompanying drawings in the embodiments of the present invention. Apparently, the described embodiments are merely some embodiments of the present invention.

### Embodiment 1

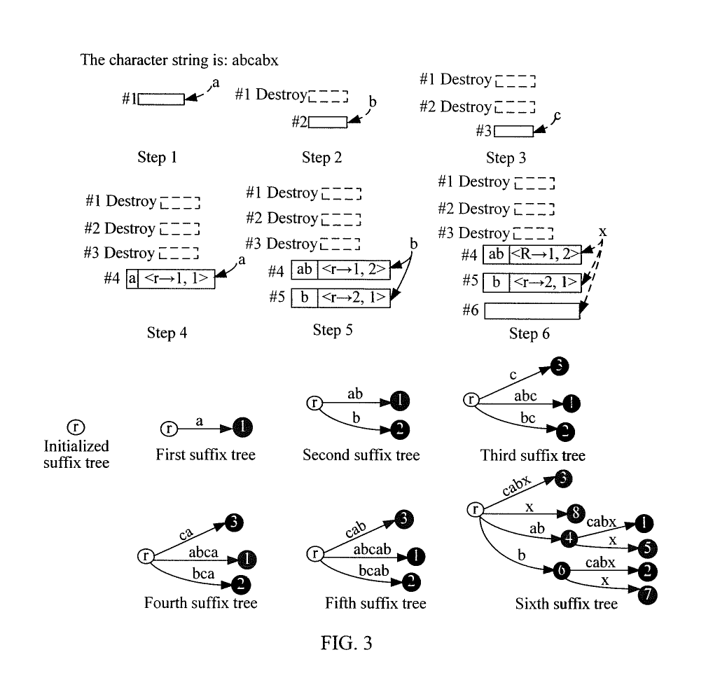

FIG. 2 is a flowchart of a method for mining a maximal repeated sequence according to an embodiment of the present invention. As shown in FIG. 2, the method may include the following steps:

201: Acquire a character.

The character belongs to a character string, the character string is a long sequence including multiple characters, and the character is any character in the character string. Preferably, characters may be read one by one from a database in which the character string is stored and according to an order of characters in the character string. For example, assuming that the character string is “abcabxa”, the characters that are read according to the order of the characters in the character string are “a”, “b”, “c”, “a”, “b”, “x”, and “a” respectively.

Further, it is also feasible that characters sent by another system are received in chronological order in a period of time, to form a character string. For example, characters that are separately received at different moments in a period of time are “a”, “b”, “c”, “a”, “b”, “x”, and “a”, and in this case, a character string received in this period of time is “abcabxa”.

202: Append the character to each pipeline in a pipeline set, and separately determine whether a sequence in each pipeline appended with the character is the same as a corresponding sequence on a suffix tree.

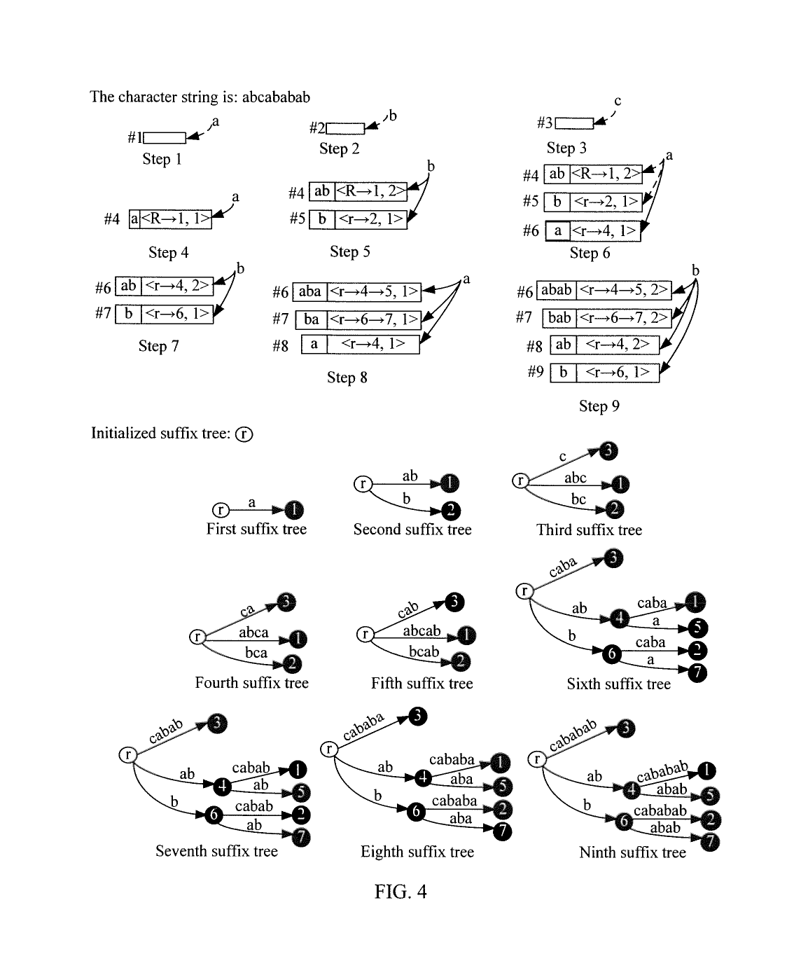

The pipeline set includes at least one pipeline, the pipeline includes a sequence and a location pointer, the sequence includes a character the same as a character that is in the character string in which the character is located and that is in front of the character, and the location pointer points to a location, on the suffix tree, of a tail character of the sequence included in the pipeline. For example, as shown in FIG. 4, the character string is “abcababab”, a character read in step 6 is “a”, and in this case, the pipeline set includes #4 pipeline and #5 pipeline, and the suffix tree is a fifth suffix tree. #4 pipeline includes a sequence “ab” that is the same as a sequence in front of the character “a” and a location pointer <r→1, 2>, on the fifth suffix tree, of a tail character “b” in the sequence “ab”. #5 pipeline includes a sequence “b” that is the same as a sequence in front of the character “a” and a location pointer <r→2, 1>, on the fifth suffix tree, of the sequence “b”.

The appending the character to a pipeline refers to storing the character at the end of a sequence included in the pipeline. For example, if a sequence included in a pipeline 1 is “ab” and the acquired character is “x”, appending the character to the pipeline 1 is adding the character “x” to the sequence “ab”, and storing the sequence in a form of “abx” in the pipeline 1.

Preferably, the separately determining whether a sequence in each pipeline appended with the character is the same as a corresponding sequence on the suffix tree may include:

on the suffix tree, separately moving a location pointer in each pipeline, so that the location pointer points to a location of a next character adjacent to the tail character of the sequence included in the pipeline; and

determining whether the character to which the moved location pointer points is the same as the character; if the character to which the moved location pointer points is different from the character, determining that the sequence in the pipeline appended with the character is different from the corresponding sequence on the suffix tree; or if the character to which the moved location pointer points is the same as the character, determining that the sequence in the pipeline appended with the character is the same as the corresponding sequence on the suffix tree.

For example, as shown in FIG. 4, in step 6, location pointers of #4 pipeline and #5 pipeline are moved sequentially, so that the location pointers point to a location <r→1, 3> and a location <r→2, 2>; it is found that a character at the location <r→1, 3> and a character at the location <r→2, 2> are both “c”, which is different from the character, and in this case, it is determined that a sequence “aba” in #4 pipeline appended with the character is different from a corresponding sequence on the fifth suffix tree, and a sequence “ba” in #5 pipeline appended with the character is different from a corresponding sequence on the fifth suffix tree.

203: In the pipeline set, if there exists such a first pipeline that after the character is appended to the first pipeline, a sequence in the first pipeline is different from a corresponding sequence on the suffix tree, determine a maximal repeated sequence according to a first preset policy and the sequence in the first pipeline.

For example, as shown in FIG. 4, in step 6, the sequence “aba” in #4 pipeline appended with the character “a” is different from the corresponding sequence on the fifth suffix tree, and in this case, the character “a” is not appended to #4 pipeline, and meanwhile, it is determined, according to the first preset policy and the sequence “ab” in #4 pipeline, whether the sequence “ab” in #4 pipeline is a maximal repeated sequence.

Preferably, the determining a maximal repeated sequence according to a first preset policy and the sequence in the first pipeline may include:

detecting, in the character string, whether left characters adjacent to sequences that are the same as the sequence in the first pipeline are characters of a same type, and detecting whether right characters adjacent to the sequences that are the same as the sequence in the first pipeline are characters of a same type; and

if the left characters adjacent to the sequences that are the same as the sequence in the first pipeline are not characters of a same type, and the right characters adjacent to the sequences that are the same as the sequence in the first pipeline are not characters of a same type, determining that the sequence in the first pipeline is the maximal repeated sub-sequence; or if the left characters adjacent to the sequences that are the same as the sequence in the first pipeline are characters of a same type, or the right characters adjacent to the sequences that are the same as the sequence in the first pipeline are characters of a same type, or the left characters adjacent to the sequences that are the same as the sequence in the first pipeline are characters of a same type and the right characters adjacent to the sequences that are the same as the sequence in the first pipeline are characters of a same type, determining that the sequence in the first pipeline is not the maximal repeated sequence, and destroying the first pipeline.

The detecting, in the character string, whether left characters adjacent to sequences that are the same as the sequence in the first pipeline are characters of a same type, and detecting whether right characters adjacent to the sequences that are the same as the sequence in the first pipeline are characters of a same type may include:

acquiring, in the character string, a set of left characters adjacent to the sequences that are the same as the sequence in the first pipeline; if the character set includes characters of a same type, determining that the left characters adjacent to the sequences that are the same as the sequence in the first pipeline are characters of a same type; or if the character set includes at least two types of characters, determining that the left characters adjacent to the sequences that are the same as the sequence in the first pipeline are not characters of a same type; and

on the suffix tree, determining whether a character to which a location pointer of the first pipeline points is the same as the character, if the character to which the location pointer of the first pipeline points is the same as the character, determining that the right characters adjacent to the sequences that are the same as the sequence in the first pipeline are characters of a same type, or if the character to which the location pointer of the first pipeline points is different from the character, determining that the right characters adjacent to the sequences that are the same as the sequence in the first pipeline are not characters of a same type.

For example: the read character is “x”, the sequence included in the first pipeline is “ab”, the first pipeline appended with “x” is different from a corresponding sequence on the suffix tree, and the sequence “ab” is in a character string “#abcabxa”. First, a set of left characters adjacent to sequences that are the same as the sequence “ab” and that are in the character string “#abcabxa” is acquired, where the set of left characters is (“#”, “c”), and it is determined that the left characters adjacent to the sequences that are the same as the sequence in the first pipeline are not characters of a same type; secondly, if a character to which a location pointer <r→4, 1> of the first pipeline points on the suffix tree is “a”, which is different from the read character “x”, it is determined that the right characters adjacent to the sequences that are the same as the sequence in the first pipeline are not characters of a same type. Therefore, it can be learned that the sequence “ab” included in the first pipeline is a maximal repeated sequence.

Further, the method further includes:

destroying the first pipeline when reading a next character.

In general cases, when a maximal repeated sequence is acquired by using the foregoing method, incremental mining can be implemented and a computation rate can be improved. However, the acquired maximal repeated sequence may include a relatively large quantity of redundant sub-sequences, and cannot effectively express a minimal unit of a sequence pattern, which does not help comprehension or analysis. For example, when maximal repeated sequence mining is performed on a sequence “#xyababpqababmn$”, “abab” may be used as a maximal repeated sequence thereof, while the sub-sequence “abab” includes two smaller identical sub-sequences “ab” that are concatenated. Therefore, to make the mined sequence be a maximal non-concatenated repeated sequence, while the foregoing method is performed, further, the method further includes:

in the pipeline set, if there exists such a second pipeline that after the character is appended to the second pipeline, a sequence in the second pipeline is the same as a corresponding sequence on the suffix tree, appending the character to the second pipeline, and pointing a location pointer of the second pipeline to a location, on the suffix tree, of a tail character of the sequence included in the second pipeline appended with the character; and

determining a maximal non-concatenated repeated sequence according to the location pointer of the second pipeline and a second preset policy.

Preferably, the determining a maximal non-concatenated repeated sequence according to the location pointer of the second pipeline and a second preset policy may include:

determining whether the location pointer of the second pipeline is the same as a location pointer of a reference pipeline of the second pipeline, where the reference pipeline of the second pipeline is a pipeline that is in the pipeline set and that includes a sequence whose initial character is the same as an initial character of the sequence included in the second pipeline when the initial character of the sequence included in the second pipeline is read; and

if the location pointer of the second pipeline is the same as the location pointer of the reference pipeline of the second pipeline, determining that the sequence in the second pipeline is the maximal non-concatenated repeated sequence.

For example, an initial character of the sequence included in the second pipeline is “a”, and when “a” is read (that is, when the second pipeline is still an empty pipeline), each pipeline in the pipeline set is traversed; it is found that an initial character included in #4 pipeline is also “a”, and at this time, the location pointer of #4 pipeline is <r→4→2, 1>. In this case, #4 pipeline is determined as the reference pipeline of the second pipeline, and the location pointer <r→4→2, 1> is determined as a reference pointer of the second pipeline. In a process of continuously appending new characters to the second pipeline, if the location pointer of the second pipeline reaches <r→4→2, 1>, a sequence included in the second pipeline when the location pointer of the second pipeline is <r→4→2, 1> is determined as a maximal non-concatenated repeated sequence.

Further, before the character is read, an empty pipeline is established; and

correspondingly, the method further includes:

traversing an initial character of each branch of the suffix tree;

if an initial character the same as the character exists, storing the character into the empty pipeline, and pointing a location pointer of the empty pipeline to a location, on the suffix tree, of the initial character the same as the character; and in the pipeline set, if there exists such a third pipeline that after the character is appended to the third pipeline, a sequence in the third pipeline is different from a corresponding sequence on the suffix tree, splitting, starting from a location to which a location pointer of the third pipeline points, a corresponding branch on the suffix tree into two branches, and inserting the character into each branch on the suffix tree after splitting; or if there exists such a third pipeline that after the character is appended to the third pipeline, a sequence in the third pipeline is the same as a corresponding sequence on the suffix tree, inserting the character into each branch on the suffix tree; or

if an initial character the same as the character does not exist, destroying the empty pipeline, and splitting a new branch from a root node of the suffix tree; and in the pipeline set, if there exists such a third pipeline that after the character is appended to the third pipeline, a sequence in the third pipeline is different from a corresponding sequence on the suffix tree, splitting, starting from a location to which a location pointer of the third pipeline points, a corresponding branch on the suffix tree into two branches, and inserting the character into each branch of the suffix tree after splitting; or if there exists such a third pipeline that after the character is appended to the third pipeline, a sequence in the third pipeline is the same as a corresponding sequence on the suffix tree, inserting the character into each branch of the suffix tree after splitting.

Further, to conveniently and quickly use acquired pattern information to perform analysis in subsequent work, the method further includes:

storing related information of the determined maximal repeated sequence and related information of the determined maximal non-concatenated repeated sequence into a preset pattern information table, and expressing, on the suffix tree, the related information of the maximal repeated sequence and the related information of the maximal non-concatenated repeated sequence, where the related information includes: a sequence number, sequence content, and a sequence length.

For example, assuming that 1000 pieces of pattern information have been found and now comparison needs to be performed for a sequence “ab” currently being identified, in this case, if the whole information table is searched, comparison needs to be performed 1000 times from the beginning to the end of the table. However, if the pattern information is stored on the suffix tree according to a storage rule of the suffix tree, only patterns on a branch “ab” need to be involved in comparison, and if there are 10 pieces of pattern information on the branch “ab”, only the 10 pieces of pattern information need to be involved in comparison, which increases a comparison speed and facilitates retrieval.

The expressing, on the suffix tree, the related information of the maximal repeated sequence and the related information of the maximal non-concatenated repeated sequence is:

separately expressing, on a corresponding branch of the suffix tree, a pattern number of a sequence pattern and a remaining length of the sequence pattern that corresponds to the pattern number.

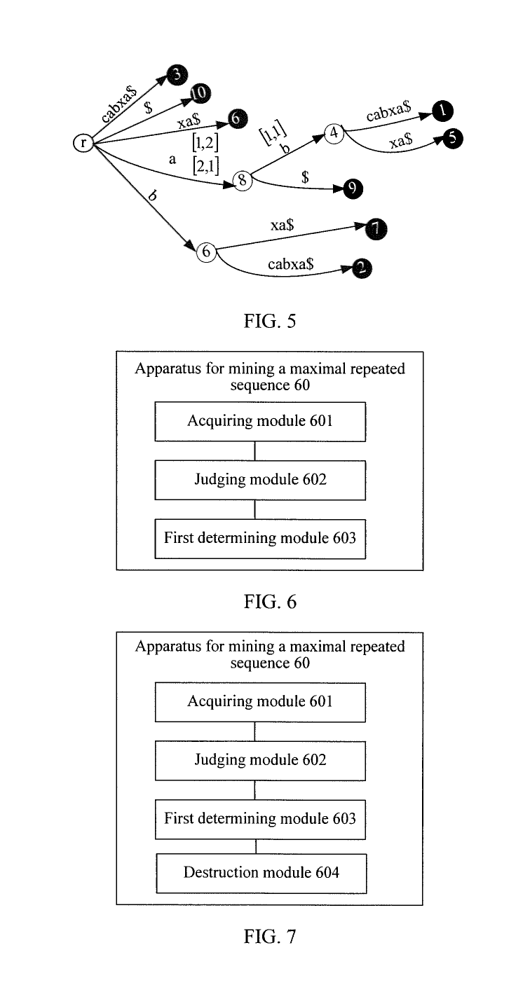

For example, related information of the determined maximal non-concatenated repeated sequences “ab” and “b” is stored in a preset pattern information table 1, and as show in FIG. 5, corresponding to table 1, related information of mined sequence patterns is expressed on a suffix tree, where a character stored on a branch r→8 of the suffix tree is “a”, which is initial characters of sequences corresponding to a pattern number 1 and a pattern number 2 in the pattern information table, and in this case, related information [1,2] about the pattern number 1 and a length of the sequence corresponding to the pattern number 1, and related information [2,1] about the pattern number 2 and a length of the sequence corresponding to the pattern number 2 are stored on the branch r→8. Searching is performed downward along the branch r→8, related information [1,1] about the pattern number 1 and a remaining length 1 of the sequence corresponding to the pattern number 1 is stored on a branch 8→4 corresponding to a remaining character of the sequence corresponding to the pattern number 1.

TABLE 1

| Pattern number | Content | Total length |
|---|---|---|
| 1 | “ab” | 2 |
| 2 | “a” | 1 |

The following specifically describes the foregoing method by separately using an example of mining a maximal repeated sequence in a character string “abcabx” and an example of mining a maximal non-concatenated repeated sequence in a character string “abcababab”.

FIG. 3 is a schematic flowchart of mining a maximal repeated sequence in a sequence “abcabx”, and as shown in FIG. 3, the following steps may be included:

Step 1: Create an empty pipeline #1; read a character “a”, and if an initial character the same as “a” does not exist on an initialized suffix tree, skip storing the character “a” into #1 pipeline, and destroy #1 pipeline; meanwhile, establish a new branch r→1 from a root node of the initialized suffix tree, and insert the character “a” into the branch r→1, to form a first suffix tree, where the initialized suffix tree \textcircled{r}.

Step 2: Create an empty pipeline #2; read a next character “b”, traverse an initial character on each branch of the first suffix tree from a root node of the first suffix tree, and if it is found that there is no character the same as the character “b”, skip inserting the character “b” into #2 pipeline, and destroy #2 pipeline; meanwhile, establish a new branch r→2 from the root node of the first suffix tree, and separately insert the character “b” into the branch r→1 and the branch r→2, to form a second suffix tree.

Step 3: Create an empty pipeline #3; read a next character “c”, traverse an initial character on each branch of the first suffix tree from a root node of the second suffix tree, and if it is found that there is no character the same as the character “c”, skip inserting the character “c” into #3 pipeline, and destroy #3 pipeline; meanwhile, establish a new branch r→3 from the root node of the second suffix tree, and separately insert the character “b” into the branch r→1, the branch r→2, and the branch r→3, to form a third suffix tree.

Step 4: Create an empty pipeline #4; read a next character “a”, traverse an initial character on each branch of the first suffix tree from a root node of the third suffix tree, and if it is found that the initial character on the branch r→1 is the same as the read character “a”, store the character “a” into #4 pipeline, and set a location pointer of #4 pipeline to be <r→1, 1>; and meanwhile separately insert the character “a” into the branch r→1, the branch r→2, and the branch r→3, to form a fourth suffix tree.

Step 5: Create an empty pipeline #5; read a next character “b”, move the location pointer <r→1, 1> in #4 pipeline to a next location <r→1, 2>, and if a character at the location <r→1, 2> on the fourth suffix tree is the same as the appended character “b”, append the character “b” to #4 pipeline, and meanwhile set the location pointer of #4 pipeline to be <r→1, 2>; traverse an initial character of each branch of the fourth suffix tree from a root node of the fourth suffix tree, and if it is found that the initial character on the branch r→2 is the same as the read character “b”, store the character “b” into #5 pipeline, and meanwhile, set a location pointer of #5 pipeline to be <r→2, 1>; and separately insert the character “b” into the branch r→1, the branch r→2, and the branch r→3, to form a fifth suffix tree.

Step 6: Create an empty pipeline #6; read a next character “x”, move the location pointer <r→1, 2> in #4 pipeline to a next location <r→1, 3>, move the location pointer <r→2, 1> in #5 pipeline to a next location <r→2, 2>, and if it is found that characters at the location <r→1, 3> and the location <r→2, 2> on the fifth suffix tree are both “c”, which is different from the read character “x”, skip appending the character “x” to #4 pipeline and #5 pipeline, determine whether sequences included in #4 pipeline and in #5 pipeline are maximal repeated sequences, and destroy #4 pipeline and #5 pipeline.

In the character string “abcabx” that is already read, left characters: empty character and “c”, which are adjacent to sequences “ab” that are the same as the sequence included in #4 pipeline are acquired, and in this case, it is determined that the left characters adjacent to the sequences “ab” that are the same as the sequence included in #4 pipeline are not characters of a same type. Meanwhile, a character to which the location pointer of #4 pipeline points on the fifth suffix tree is “b”, which is different from the read character “x”, and in this case, it is determined that right characters adjacent to the sequences “ab” that are the same as the sequence included in #4 pipeline are not characters of a same type. Therefore, the left characters adjacent to the sequences “ab” that are the same as the sequence included in #4 pipeline are not characters of a same type, and the right characters adjacent to the sequences “ab” that are the same as the sequence included in #4 pipeline are not characters of a same type either; in this case, it is determined that the sequence “ab” included in #4 pipeline is a maximal repeated sequence of the character string “abcabx”.

In the character string “abcabx” that is already read, left characters: “a” and “a”, which are adjacent to sequences “b” that are the same as the sequence included in #5 pipeline are acquired, and in this case, it is determined that the left characters adjacent to the sequences “b” that are the same as the sequence included in #5 pipeline are characters of a same type. Meanwhile, a character to which the location pointer of #5 pipeline points on the fifth suffix is “b”, which is different from the read character “x”, and in this case, it is determined that right characters adjacent to the sequences “b” that are the same as the sequence included in #5 pipeline are not characters of a same type. Therefore, the left characters adjacent to the sequences “b” that are the same as the sequence included in #5 pipeline are characters of a same type, and in this case, it is determined that the sequence “b” included in #5 pipeline is not a maximal repeated sequence of the character string “abcabx”.

In addition, an initial character of each branch of the fifth suffix tree is traversed from a root node of the fifth suffix tree, and if it is found that there is no initial character the same as the read character “x”, the character “x” is not stored into #6 empty pipeline, and #6 empty pipeline is destroyed. Moreover, a new branch r→8 is established from the root node of the fifth suffix tree; the branch r→1 is split into two branches: r→4→1 and r→4→5, from the location <r→1, 2> on the fifth suffix tree, the branch r→2 is split into two branches: r→6→2 and r→6→7, from the location <r→2, 1> on the fifth suffix tree, and the character “x” is separately inserted into the branches r→3, r→8, r→4→1, r→4→5, r→6→2, and r→6→7, to form a sixth suffix tree.

FIG. 4 is a schematic flowchart of mining a maximal non-concatenated repeated sequence in a sequence “abcababab”, and as shown in FIG. 4, the following steps may be included:

Step 1: Create an empty pipeline #1; read a character “a”, and if an initial character the same as “a” does not exist on an initialized suffix, skip storing the character “a” into #1 pipeline, and destroy #1 pipeline; meanwhile, establish a new branch r→1 from a root node of the initialized suffix tree, and insert the character “a” into the branch r→1, to form a first suffix tree, where the initialized suffix tree is \textcircled{r}.

Step 2: Create an empty pipeline #2; read a next character “b”, traverse an initial character on each branch of the first suffix tree from a root node of the first suffix tree, and if it is found that there is no character the same as the character “b”, skip inserting the character “b” into #2 pipeline, and destroy #2 pipeline; meanwhile, establish a new branch r→2 from the root node of the first suffix tree, and separately insert the character “b” into the branch r→1 and the branch r→2, to form a second suffix tree.

Step 3: Create an empty pipeline #3; read a next character “c”, traverse an initial character on each branch of the first suffix tree from a root node of the second suffix tree, and if it is found that there is no character the same as the character “b”, skip inserting the character “c” into #3 pipeline, and destroy #3 pipeline; meanwhile, establish a new branch r→3 from the root node of the second suffix tree, and separately insert the character “b” into the branch r→1, the branch r→2, and the branch r→3, to form a third suffix tree.

Step 4: Create an empty pipeline #4; read a next character “a”, traverse an initial character on each branch of the first suffix tree from a root node of the third suffix tree, and if it is found that the initial character on the branch r→1 is the same as the read character “a”, store the character “a” into #4 pipeline, and set a location pointer of #4 pipeline to be <r→1, 1>; and meanwhile, separately insert the character “b” into the branch r→1, the branch r→2, and the branch r→3, to form a fourth suffix tree.

Step 5: Create an empty pipeline #5; read a next character “b”, move the location pointer <r→1, 1> in #4 pipeline to a next location <r→1, 2>, and if a character at the location <r→1, 2> on the fourth suffix tree is the same as the appended character “b”, append the character “b” to #4 pipeline, and meanwhile, set the location pointer of #4 pipeline to be <r→1, 2>; traverse an initial character of each branch of the fourth suffix tree from a root node of the fourth suffix tree, and if it is found that the initial character on the branch r→2 is the same as the read character “b”, store the character “b” into #5 pipeline, and meanwhile, seta location pointer of #5 pipeline to be <r→2, 1>; and separately insert the character “b” into the branch r→1, the branch r→2, and the branch r→3, to form a fifth suffix tree.

Step 6: Create an empty pipeline #6; read a next character “a”, move the location pointer <r→1, 2> in #4 pipeline to a next location <r→1, 3>, move the location pointer <r→2, 1> in #5 pipeline to a next location <r→2, 2>, and if it is found that characters at the location <r→1, 3> and the location <r→2, 2> on the fifth suffix tree are both “c”, which is different from the read character “a”, skip appending the character “a” to #4 pipeline and #5 pipeline, determine whether sequences included in #4 pipeline and in #5 pipeline are maximal repeated sequences, and destroy #4 pipeline and #5 pipeline.

In the character string “abcaba” that is already read, left characters: empty character and “c”, which are adjacent to sequences “ab” that are the same as the sequence included in #4 pipeline are acquired, and in this case, it is determined that the left characters adjacent to the sequences “ab” that are the same as the sequence included in #4 pipeline are not characters of a same type. Meanwhile, a character to which the location pointer of #4 pipeline points on the fifth suffix is “b”, which is different from the read character “a”, and in this case, it is determined that right characters adjacent to the sequences “ab” that are the same as the sequence included in #4 pipeline are not characters of a same type. Therefore, the left characters adjacent to the sequences “ab” that are the same as the sequence included in #4 pipeline are not characters of a same type, and the right characters adjacent to the sequences “ab” that are the same as the sequence included in #4 pipeline are not characters of a same type either; in this case, it is determined that the sequence “ab” included in #4 pipeline is a maximal repeated sequence of the character string “abcaba”.

In the character string “abcaba” that is already read, left characters: “a” and “a”, which are adjacent to sequences “b” that are the same as the sequence included in #5 pipeline are acquired, and in this case, it is determined that the left characters adjacent to the sequences “ab” that are the same as the sequence included in #5 pipeline are characters of a same type. Meanwhile, a character to which the location pointer of #5 pipeline points on the fifth suffix is “b”, which is different from the read character “a”, and in this case, it is determined that right characters adjacent to the sequences “b” that are the same as the sequence included in #5 pipeline are not characters of a same type. Therefore, the left characters adjacent to the sequences “b” that are the same as the sequence included in #5 pipeline are characters of a same type, and in this case, it is determined that the sequence “b” included in #5 pipeline is not a maximal repeated sequence of the character string “abcaba”.

In addition, an initial character of each branch of the fifth suffix tree is traversed from a root node of the fifth suffix tree, and if it is found that the initial character on the branch r→1 is the same as the read character “a”, the character “a” is stored into #6 pipeline. Meanwhile, the branch r→1 is split into two branches: r→4→1 and r→4→5, from the location <r→1, 2> on the fifth suffix tree, the branch r→2 is split into two branches: r→6→2 and r→6→7, from the location <r→2, 1> on the fifth suffix tree, and the character “a” is separately inserted into the branches r→3, r→4→1, r→4→5, r→6→2, and r→6→7, to form a sixth suffix tree; and corresponding to the sixth suffix tree, a location pointer of #6 pipeline is set to be <r→4, 1>.

Step 7: Create an empty pipeline #7; read a next character “b”, move a location pointer <r→4, 1> in #6 pipeline to a next location <r→4, 2>, and if it is found that a character at the location <r→4, 2> on the sixth suffix tree is the same as the read character “b”, append the character “b” to #6; meanwhile, traverse an initial character of each branch of the sixth suffix tree from a root node of the sixth suffix tree, and if it is found that the initial character on the branch r→6 is the same as the read character “b”, store the character “b” into #7 pipeline, and meanwhile, seta location pointer of #7 pipeline to be <r→6, 1>; and separately insert the character “b” into the branches r→3, r→4→1, r→4→5, r→6→2, and r→6→7, to form a seventh suffix tree.

Step 8: Create an empty pipeline #8; read a next character “a”, move the location pointer <r→4, 2> in #6 pipeline to next locations <r→4→1, 1> and <r→4→5, 1>, move the location pointer <r→6, 1> in #7 pipeline to next locations <r→6→2, 1> and <r→6→7, 1>, and if it is found that characters at the locations <r→4→5, 1> and <r→6→7, 1> are the same as the read character “a”, append the character “a” to #6 pipeline and #7 pipeline, and set the location pointers of #6 pipeline and #7 pipeline to be <r→4→5, 1> and <r→6→7, 1>; use #6 pipeline as a reference pipeline of #8 pipeline, and record the location pointer <r→4, 2> of #6 pipeline, where the location pointer of #6 pipeline is <r→4, 2> when the character “a” is read; and

traverse an initial character of each branch of the seventh suffix tree from a root node of the seventh suffix tree, and if it is found that the initial character on the branch r→4 is the same as the read character “a”, store the character “a” into #8 pipeline, and meanwhile, set a location pointer of #8 pipeline to be <r→4, 1>; and separately insert the character “a” into the branches r→3, r→4→1, r→4→5, r→6→2, and r→6→7, to form an eighth suffix tree.

Step 9: Create an empty pipeline #9; read a next character “b”, move the location pointer <r→4→5, 1> in #6 pipeline, the location pointer <r→6→7, 1> in #7 pipeline, and the location pointer <r→4, 1> in #8 pipeline to next locations <r→4→5, 2>, <r→6→7, 2>, and <r→4, 2>, and if it is found that characters at the locations <r→4→5, 2>, <r→6→7, 2>, and <r→4, 2> on the eighth suffix tree are the same as the read character “b”, append the character “b” to #6 pipeline, #7 pipeline, and #8 pipeline; meanwhile, set the location pointer of #6 pipeline to be <r→4→5, 2>, set the location pointer of #7 pipeline to be <r→6→7, 2>, and set the location pointer of #8 pipeline to be <r→4, 2>; in this case, the location pointer of #8 pipeline is the same as the recorded location pointer of the reference pipeline #6 of #8 pipeline, and in this case, it is determined that a sequence in #6 pipeline includes repeated sequences having a concatenated structure and that a sequence in #8 pipeline is a maximal non-concatenated repeated sequence, output the maximal non-concatenated repeated sequence, and destroy #6 pipeline and #8 pipeline; and

traverse an initial character of each branch of the eighth suffix tree from the root node of the seventh suffix tree, and if it is found that the initial character on the branch r→6 is the same as the read character “b”, store the character “b” into #9 pipeline, and meanwhile, set a location pointer of #9 pipeline to be <r→6, 1>; and separately insert the character “b” into the branches r→3, r→4→1, r→4→5, r→6→2, and r→6→7, to form a ninth suffix tree.

It can be learned from the above that, this embodiment of the present invention provides a method for mining a maximal repeated sequence, where a character is acquired; the character is appended to each pipeline in a pipeline set, and it is separately determined whether a sequence in each pipeline appended with the character is the same as a corresponding sequence on a suffix tree, where the pipeline set includes at least one pipeline, the pipeline includes a sequence and a location pointer, the sequence includes a character the same as a character that is in a character string in which the character is located and that is in front of the character, and the location pointer points to a location, on the suffix tree, of a tail character of the sequence included in the pipeline; and in the pipeline set, if there exists such a first pipeline that after the character is appended to the first pipeline, a sequence in the first pipeline is different from a corresponding sequence on the suffix tree, a maximal repeated sequence is determined according to a first preset policy and the sequence in the first pipeline. In this way, a maximal repeated sequence is mined by means of a combination of a pipeline structure and a suffix tree structure, which improves a computation rate. Besides, in the pipeline set, if there exists such a second pipeline that after the character is appended to the second pipeline, a sequence in the second pipeline is the same as a corresponding sequence on the suffix tree, the character is appended to the second pipeline, and a location pointer of the second pipeline is pointed to a location, on the suffix tree, of a tail character of the sequence included in the second pipeline appended with the character; and a maximal non-concatenated repeated sequence is determined according to the location pointer of the second pipeline and a second preset policy, so that the mined maximal repeated sequence is a non-concatenated repeated sequence, which avoids problems in the prior art that incremental mining cannot be implemented, a computation amount is large, and a mined maximal repeated sequence includes a redundant concatenated structure and cannot effectively express a minimal unit of a sequence pattern.

### Embodiment 2

FIG. 6 is an apparatus 60 for mining a maximal repeated sequence according to an embodiment of the present invention; as shown in FIG. 6, the apparatus includes an acquiring module 601, a judging module 602, and a first determining module 603.

The acquiring module 601 is configured to acquire a character.

The character belongs to a character string, the character string is a long sequence including multiple characters, and the character is any character in the character string. Preferably, characters may be read one by one from a database in which the character string is stored and according to an order of characters in the character string. For example, assuming that the character string is “abcabxa”, the characters that are read according to the order of the characters in the character string are “a”, “b”, “c”, “a”, “b”, “x”, and “a” respectively.

Further, it is also feasible that characters sent by another system are received in chronological order in a period of time, to forma character string. For example, characters that are separately received at different moments in a period of time are “a”, “b”, “c”, “a”, “b”, “x”, and “a”, and in this case, a character string received in this period of time is “abcabxa”.

The judging module 602 is configured to: append the character acquired by the acquiring module 601 to each pipeline in a pipeline set, and separately determine whether a sequence in each pipeline appended with the character is the same as a corresponding sequence on the suffix tree.

The pipeline set includes at least one pipeline, the pipeline includes a sequence and a location pointer, the sequence includes a character the same as a character that is in the character string in which the character is located and that is in front of the character, and the location pointer points to a location, on the suffix tree, of a tail character of the sequence included in the pipeline. For example, as shown in FIG. 4, the character string is “abcababab”, a character read in step 6 is “a”, and in this case, the pipeline set includes #4 pipeline and #5 pipeline, and the suffix tree is a fifth suffix tree. #4 pipeline includes a sequence “ab” that is the same as a sequence in front of the character “a” and a location pointer <r→1, 2>, on the fifth suffix tree, of a tail character “b” in the sequence “ab”. #5 pipeline includes a sequence “b” that is the same as a sequence in front of the character “a” and a location pointer <r→2, 1>, on the fifth suffix, of the sequence “b”.

The appending the character to a pipeline refers to storing the character at the end of a sequence included in the pipeline. For example, if a sequence included in a pipeline 1 is “ab” and the acquired character is “x”, appending the character to the pipeline 1 is adding the character “x” to the sequence “ab”, and storing the sequence in a form of “abx” in the pipeline 1.

The first determining module 603 is configured to: in the pipeline set, if there exists such a first pipeline that after the character is appended to the first pipeline, a sequence in the first pipeline is different from a corresponding sequence on the suffix tree, determine a maximal repeated sequence according to a first preset policy and the sequence in the first pipeline.

For example, as shown in FIG. 4, in step 6, the sequence “aba” in #4 pipeline appended with the character “a” is different from the corresponding sequence on the fifth suffix tree, and in this case, the character “a” is not appended to #4 pipeline, and meanwhile, it is determined, according to the first preset policy and the sequence “ab” in #4 pipeline, whether the sequence “ab” in #4 pipeline is a maximal repeated sequence.

Further, the judging module 602 is specifically configured to:

on the suffix tree, separately move a location pointer in each pipeline, so that the location pointer points to a location of a next character adjacent to the tail character of the sequence included in the pipeline; and

determine whether the character to which the moved location pointer points is the same as the character; if the character to which the moved location pointer points is different from the character, determine that the sequence in the pipeline appended with the character is different from the corresponding sequence on the suffix tree; or if the character to which the moved location pointer points is the same as the character, determine that the sequence in the pipeline appended with the character is the same as the corresponding sequence on the suffix tree.

For example, as shown in FIG. 4, in step 6, location pointers of #4 pipeline and #5 pipeline are moved sequentially, so that the location pointers point to a location <r→1, 3> and a location <r→2, 2>; it is found that a character at the location <r→1, 3> and a character at the location <r→2, 2> are both “c”, which is different from the character, and in this case, it is determined that a sequence “aba” in #4 pipeline appended with the character is different from a corresponding sequence on the fifth suffix tree, and a sequence “ba” in #5 pipeline appended with the character is different from a corresponding sequence on the fifth suffix tree.

Further, the first determining module 603 is specifically configured to:

detect, in the character string, whether left characters adjacent to sequences that are the same as the sequence in the first pipeline are characters of a same type, and detect whether right characters adjacent to the sequences that are the same as the sequence in the first pipeline are characters of a same type; and

if the left characters adjacent to the sequences that are the same as the sequence in the first pipeline are not characters of a same type, and the right characters adjacent to the sequences that are the same as the sequence in the first pipeline are not characters of a same type, determine that the sequence in the first pipeline is the maximal repeated sub-sequence; or if the left characters adjacent to the sequences that are the same as the sequence in the first pipeline are characters of a same type, or the right characters adjacent to the sequences that are the same as the sequence in the first pipeline are characters of a same type, or the left characters adjacent to the sequences that are the same as the sequence in the first pipeline are characters of a same type and the right characters adjacent to the sequences that are the same as the sequence in the first pipeline are characters of a same type, determine that the sequence in the first pipeline is not the maximal repeated sequence, and destroy the first pipeline.

The detecting, in the character string, whether left characters adjacent to sequences that are the same as the sequence in the first pipeline are characters of a same type, and detecting whether right characters adjacent to the sequences that are the same as the sequence in the first pipeline are characters of a same type may include:

acquiring, in the character string, a set of left characters adjacent to the sequences that are the same as the sequence in the first pipeline; if the character set includes characters of a same type, determining that the left characters adjacent to the sequences that are the same as the sequence in the first pipeline are characters of a same type; or if the character set includes at least two types of characters, determining that the left characters adjacent to the sequences that are the same as the sequence in the first pipeline are not characters of a same type; and

on the suffix tree, determining whether a character to which a location pointer of the first pipeline points is the same as the character, if the character to which the location pointer of the first pipeline points is the same as the character, determining that the right characters adjacent to the sequences that are the same as the sequence in the first pipeline are characters of a same type, or if the character to which the location pointer of the first pipeline points is different from the character, determining that the right characters adjacent to the sequences that are the same as the sequence in the first pipeline are not characters of a same type. For example: the read character is “x”, the sequence included in the first pipeline is “ab”, the first pipeline appended with “x” is different from a corresponding sequence on the suffix tree, and the sequence “ab” is in a character string “#abcabxa”. First, a set of left characters adjacent to sequences that are the same as the sequence “ab” and that are in the character string “#abcabxa” is acquired, where the set of left characters is (“#”, “c”), and it is determined that the left characters adjacent to the sequences that are the same as the sequence in the first pipeline are not characters of a same type; secondly, if a character to which a location pointer <r→4, 1> of the first pipeline points on the suffix tree is “a”, which is different from the read character “x”, it is determined that the right characters adjacent to the sequences that are the same as the sequence in the first pipeline are not characters of a same type. Therefore, it can be learned that the sequence “ab” included in the first pipeline is a maximal repeated sequence.

Further, as shown in FIG. 7, the apparatus 60 for mining a maximal repeated sequence further includes:

a destruction module 604, configured to destroy the first pipeline.

In general cases, when a maximal repeated sequence is acquired by using the foregoing apparatus, incremental mining can be implemented and a computation rate can be improved. However, the acquired maximal repeated sequence may include a relatively large quantity of redundant sub-sequences, and cannot effectively express a minimal unit of a sequence pattern, which does not help comprehension or analysis. For example, when maximal repeated sequence mining is performed on a sequence “#xyababpqababmn$”, “abab” may be used as a maximal repeated sequence thereof, while the sub-sequence “abab” includes two smaller identical sub-sequences “ab” that are concatenated. Therefore, to make a mined sequence be a maximal non-concatenated repeated sequence, further, as shown in FIG. 8, the apparatus 60 for mining a maximal repeated sequence further includes:

an appending module 605, configured to: in the pipeline set, if there exists such a second pipeline that after the character is appended to the second pipeline, a sequence in the second pipeline is the same as a corresponding sequence on the suffix tree, append the character to the second pipeline, and point a location pointer of the second pipeline to a location, on the suffix tree, of a tail character of the sequence included in the second pipeline appended with the character; and

a second determining module 606, configured to determine a maximal non-concatenated repeated sequence according to the location pointer of the second pipeline and a second preset policy.

Correspondingly, the destruction module 604 is further configured to destroy the second pipeline and a reference pipeline of the second pipeline.

Further, the second determining module 606 is specifically configured to:

determine whether the location pointer of the second pipeline is the same as a location pointer of a reference pipeline of the second pipeline, where the reference pipeline of the second pipeline is a pipeline that is in the pipeline set and that includes a sequence whose initial character is the same as an initial character of the sequence included in the second pipeline when the initial character of the sequence included in the second pipeline is read; and

if the location pointer of the second pipeline is the same as the location pointer of the reference pipeline of the second pipeline, determine that the sequence in the second pipeline is the maximal non-concatenated repeated sequence.

For example, an initial character of the sequence included in the second pipeline is “a”, and when “a” is read (that is, when the second pipeline is still an empty pipeline), each pipeline in the pipeline set is traversed; it is found that an initial character included in #4 pipeline is also “a”, and at this time, the location pointer of #4 pipeline is <r→4→2, 1>. In this case, #4 pipeline is determined as the reference pipeline of the second pipeline, and the location pointer <r→4→2, 1> is determined as a reference pointer of the second pipeline. In a process of continuously appending new characters to the second pipeline, if the location pointer of the second pipeline reaches <r→4→2, 1>, a sequence included in the second pipeline when the location pointer of the second pipeline is <r→4→2, 1> is determined as a maximal non-concatenated repeated sequence.

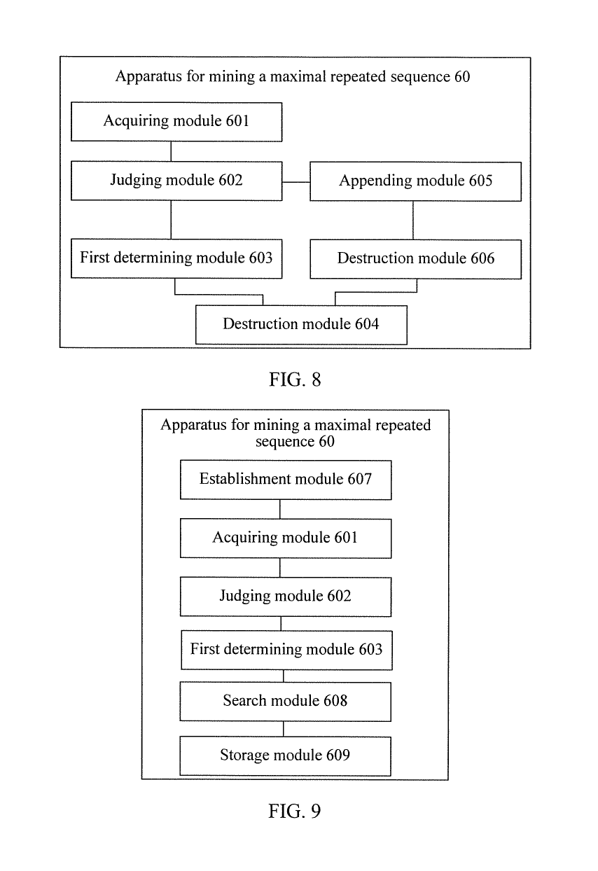

Further, as shown in FIG. 9, the apparatus 60 for mining a maximal repeated sequence further includes:

an establishment module 607, configured to establish an empty pipeline before the character is read;

a search module 608, configured to traverse an initial character of each branch of the suffix tree; and

a storage module 609, configured to: if an initial character the same as the character exists, store the character into the empty pipeline, and point a location pointer of the empty pipeline to a location, on the suffix tree, of the initial character the same as the character; and in the pipeline set, if there exists such a third pipeline that after the character is appended to the third pipeline, a sequence in the third pipeline is different from a corresponding sequence on the suffix tree, split, starting from a location to which a location pointer of the third pipeline points, a corresponding branch on the suffix tree into two branches, and insert the character into each branch on the suffix tree after splitting; or if there exists such a third pipeline that after the character is appended to the third pipeline, a sequence in the third pipeline is the same as a corresponding sequence on the suffix tree, insert the character into each branch on the suffix tree; or

if an initial character the same as the character does not exist, destroy the empty pipeline, and split a new branch from a root node of the suffix tree; and in the pipeline set, if there exists such a third pipeline that after the character is appended to the third pipeline, a sequence in the third pipeline is different from a corresponding sequence on the suffix tree, split, starting from a location to which a location pointer of the third pipeline points, a corresponding branch on the suffix tree into two branches, and insert the character into each branch of the suffix tree after splitting; or if there exists such a third pipeline that after the character is appended to the third pipeline, a sequence in the third pipeline is the same as a corresponding sequence on the suffix tree, insert the character into each branch of the suffix tree after splitting.

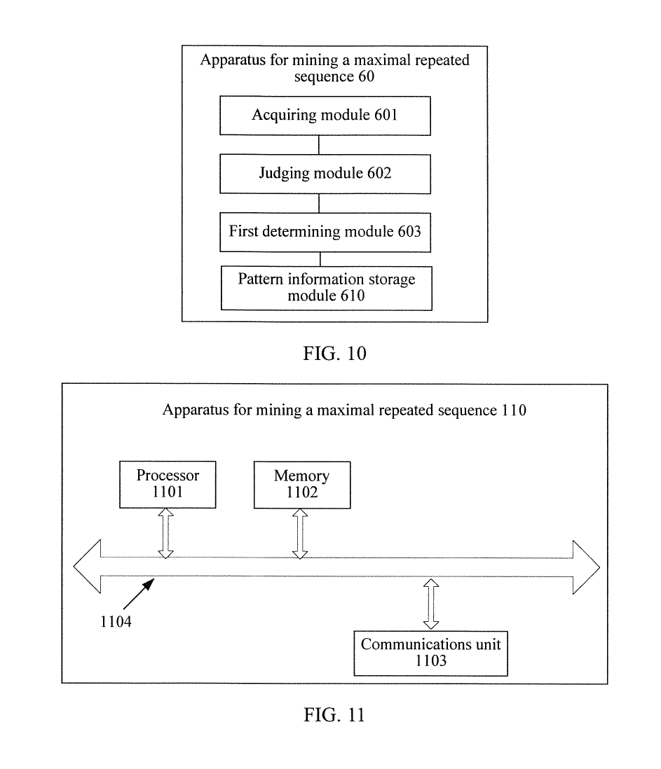

Further, to conveniently and quickly use acquired pattern information to perform analysis in subsequent work, as shown in FIG. 10, the apparatus 60 for mining a maximal repeated sequence further includes:

a pattern information storage module 610, configured to: store related information of the determined maximal repeated sequence and related information of the determined maximal non-concatenated repeated sequence into a preset pattern information table, and express, on the suffix tree, the related information of the maximal repeated sequence and the related information of the maximal non-concatenated repeated sequence, where the related information includes: a sequence number, sequence content, and a sequence length.

The expressing, on the suffix tree, the related information of the maximal non-concatenated repeated sequence is: separately expressing, on a corresponding branch of the suffix tree, a pattern number of a sequence pattern and a remaining length, on the current branch, of the sequence pattern that corresponds to the pattern number.

For example, assuming that 1000 pieces of pattern information have been found and now comparison needs to be performed for a sequence “ab” currently being identified, in this case, if the whole information table is searched, comparison needs to be performed 1000 times from the beginning to the end of the table. However, if the pattern information is stored on the suffix tree according to a storage rule of the suffix tree, only patterns on a branch “ab” need to be involved in comparison, and if there are 10 pieces of pattern information on the branch “ab”, only the 10 pieces of pattern information need to be involved in comparison, which increases a comparison speed and facilitates retrieval.

The expressing, on the suffix tree, the related information of the maximal repeated sequence and the related information of the maximal non-concatenated repeated sequence is:

separately expressing, on a corresponding branch of the suffix tree, a pattern number of a sequence pattern and a remaining length of the sequence pattern that corresponds to the pattern number.

For example, related information of the determined maximal non-concatenated repeated sequences “ab” and “b” is stored in a preset pattern information table 1, and as show in FIG. 5, corresponding to table 1, related information of mined sequence patterns is expressed on a suffix, where a character stored on a branch r→8 of the suffix tree is “a”, which is initial characters of sequences corresponding to a pattern number 1 and a pattern number 2 in the pattern information table, and in this case, related information [1,2] about the pattern number 1 and a length of the sequence corresponding to the pattern number 1, and related information [2,1] about the pattern number 2 and a length of the sequence corresponding to the pattern number 2 are stored on the branch r→8. Searching is performed downward along the branch r→8, related information [1,1] about the pattern number 1 and a remaining length 1 of the sequence corresponding to the pattern number 1 is stored on a branch 8→4 corresponding to a remaining character of the sequence corresponding to the pattern number 1.

It can be learned from the above that, this embodiment of the present invention provides an apparatus for mining a maximal repeated sequence, where a character is acquired; the character is appended to each pipeline in a pipeline set, and it is separately determined whether a sequence in each pipeline appended with the character is the same as a corresponding sequence on a suffix tree, where the pipeline set includes at least one pipeline, the pipeline includes a sequence and a location pointer, the sequence includes a character the same as a character that is in a character string in which the character is located and that is in front of the character, and the location pointer points to a location, on the suffix tree, of a tail character of the sequence included in the pipeline; and in the pipeline set, if there exists such a first pipeline that after the character is appended to the first pipeline, a sequence in the first pipeline is different from a corresponding sequence on the suffix tree, a maximal repeated sequence is determined according to a first preset policy and the sequence in the first pipeline. In this way, a maximal repeated sequence is mined by means of a combination of a pipeline structure and a suffix tree structure, which improves a computation rate. Besides, in the pipeline set, if there exists such a second pipeline that after the character is appended to the second pipeline, a sequence in the second pipeline is the same as a corresponding sequence on the suffix tree, the character is appended to the second pipeline, and a location pointer of the second pipeline is pointed to a location, on the suffix tree, of a tail character of the sequence included in the second pipeline appended with the character; and a maximal non-concatenated repeated sequence is determined according to the location pointer of the second pipeline and a second preset policy, so that the mined maximal repeated sequence is a non-concatenated repeated sequence, which avoids problems in the prior art that incremental mining cannot be implemented, a computation amount is large, and a mined maximal repeated sequence includes a redundant concatenated structure and cannot effectively express a minimal unit of a sequence pattern.

### Embodiment 3

Refer to FIG. 11, which is an apparatus 110 for mining a maximal repeated sequence according to this embodiment of the present invention. As shown in FIG. 11, the apparatus may include: a processor 1101, a memory 1102, a communications unit 1103, and at least one communications bus 1104 that is configured to implement connections and mutual communication between these apparatuses.

The processor 1101 may be a central processing unit (English: central processing unit, CPU for short).

The memory 1102 may be a volatile memory (English: volatile memory), such as a random-access memory (English: random-access memory, RAM for short); or a non-volatile memory (English: non-volatile memory), such as a read-only memory (English: read-only memory, ROM for short), a flash memory (English: flash memory), a hard disk drive (English: hard disk drive, HDD for short) or a solid-state drive (English: solid-state drive, SSD for short); or a combination of the foregoing types of memories; and provides instructions and data for the processor 1101.

The communications unit 1103 is configure to perform data transmission with an external network element.

The communications unit 1103 is configured to acquire a character.

The character belongs to a character string, the character string is a long sequence including multiple characters, and the character is any character in the character string. Preferably, characters may be read one by one from a database in which the character string is stored and according to an order of characters in the character string. For example, assuming that the character string is “abcabxa”, the characters that are read according to the order of the characters in the character string are “a”, “b”, “c”, “a”, “b”, “x”, and “a” respectively.

Further, it is also feasible that characters sent by another system are received in chronological order in a period of time, to form a character string. For example, characters that are separately received at different moments in a period of time are “a”, “b”, “c”, “a”, “b”, “x”, and “a”, and in this case, a character string received in this period of time is “abcabxa”.

The processor 1101 is configured to: append the character acquired by the communications unit 1103 to each pipeline in a pipeline set, and separately determine whether a sequence in each pipeline appended with the character is the same as a corresponding sequence on the suffix tree.

The pipeline set includes at least one pipeline, the pipeline includes a sequence and a location pointer, the sequence includes a character the same as a character that is in the character string in which the character is located and that is in front of the character, and the location pointer points to a location, on the suffix tree, of a tail character of the sequence included in the pipeline. For example, as shown in FIG. 4, the character string is “abcababab”, a character read in step 6 is “a”, and in this case, the pipeline set includes #4 pipeline and #5 pipeline, and the suffix tree is a fifth suffix tree. #4 pipeline includes a sequence “ab” that is the same as a sequence in front of the character “a” and a location pointer <r→1, 2>, on the fifth suffix tree, of a tail character “b” in the sequence “ab”. #5 pipeline includes a sequence “b” that is the same as a sequence in front of the character “a” and a location pointer <r→2, 1>, on the fifth suffix, of the sequence “b”.

The appending the character to a pipeline refers to storing the character at the end of a sequence included in the pipeline. For example, if a sequence included in a pipeline 1 is “ab” and the acquired character is “x”, appending the character to the pipeline 1 is adding the character “x” to the sequence “ab”, and storing the sequence in a form of “abx” in the pipeline 1.

The processor 1101 is further configured to: in the pipeline set, if there exists such a first pipeline that after the character is appended to the first pipeline, a sequence in the first pipeline is different from a corresponding sequence on the suffix tree, determine a maximal repeated sequence according to a first preset policy and the sequence in the first pipeline. For example, as shown in FIG. 4, in step 6, the sequence “aba” in #4 pipeline appended with the character “a” is different from the corresponding sequence on the fifth suffix tree, and in this case, the character “a” is not appended to #4 pipeline, and meanwhile, it is determined, according to the first preset policy and the sequence “ab” in #4 pipeline, whether the sequence “ab” in #4 pipeline is a maximal repeated sequence.

Further, the processor 1101 is specifically configured to:

on the suffix tree, separately move a location pointer in each pipeline, so that the location pointer points to a location of a next character adjacent to the tail character of the sequence included in the pipeline; and

determine whether the character to which the moved location pointer points is the same as the character; if the character to which the moved location pointer points is different from the character, determine that the sequence in the pipeline appended with the character is different from the corresponding sequence on the suffix tree; or if the character to which the moved location pointer points is the same as the character, determine that the sequence in the pipeline appended with the character is the same as the corresponding sequence on the suffix tree. For example, as shown in FIG. 4, in step 6, location pointers of #4 pipeline and #5 pipeline are moved sequentially, so that the location pointers point to a location <r→1, 3> and a location <r→2, 2>; it is found that a character at the location <r→1, 3> and a character at the location <r→2, 2> are both “c”, which is different from the character, and in this case, it is determined that a sequence “aba” in #4 pipeline appended with the character is different from a corresponding sequence on the fifth suffix tree, and a sequence “ba” in #5 pipeline appended with the character is different from a corresponding sequence on the fifth suffix tree.

Further, the processor 1101 is specifically configured to:

detect, in the character string, whether left characters adjacent to sequences that are the same as the sequence in the first pipeline are characters of a same type, and detect whether right characters adjacent to the sequences that are the same as the sequence in the first pipeline are characters of a same type; and

if the left characters adjacent to the sequences that are the same as the sequence in the first pipeline are not characters of a same type, and the right characters adjacent to the sequences that are the same as the sequence in the first pipeline are not characters of a same type, determine that the sequence in the first pipeline is the maximal repeated sub-sequence; or if the left characters adjacent to the sequences that are the same as the sequence in the first pipeline are characters of a same type, or the right characters adjacent to the sequences that are the same as the sequence in the first pipeline are characters of a same type, or the left characters adjacent to the sequences that are the same as the sequence in the first pipeline are characters of a same type and the right characters adjacent to the sequences that are the same as the sequence in the first pipeline are characters of a same type, determine that the sequence in the first pipeline is not the maximal repeated sequence, and destroy the first pipeline.

The detecting, in the character string, whether left characters adjacent to sequences that are the same as the sequence in the first pipeline are characters of a same type, and detecting whether right characters adjacent to the sequences that are the same as the sequence in the first pipeline are characters of a same type may include:

acquiring, in the character string, a set of left characters adjacent to the sequences that are the same as the sequence in the first pipeline; if the character set includes characters of a same type, determining that the left characters adjacent to the sequences that are the same as the sequence in the first pipeline are characters of a same type; or if the character set includes at least two types of characters, determining that the left characters adjacent to the sequences that are the same as the sequence in the first pipeline are not characters of a same type; and

on the suffix tree, determining whether a character to which a location pointer of the first pipeline points is the same as the character, if the character to which the location pointer of the first pipeline points is the same as the character, determining that the right characters adjacent to the sequences that are the same as the sequence in the first pipeline are characters of a same type, or if the character to which the location pointer of the first pipeline points is different from the character, determining that the right characters adjacent to the sequences that are the same as the sequence in the first pipeline are not characters of a same type. For example: the read character is “x”, the sequence included in the first pipeline is “ab”, the first pipeline appended with “x” is different from a corresponding sequence on the suffix tree, and the sequence “ab” is in a character string “#abcabxa”. First, a set of left characters adjacent to sequences that are the same as the sequence “ab” and that are in the character string “#abcabxa” is acquired, where the set of left characters is (“#”, “c”), and it is determined that the left characters adjacent to the sequences that are the same as the sequence in the first pipeline are not characters of a same type; secondly, if a character to which a location pointer <r→4, 1> of the first pipeline points on the suffix tree is “a”, which is different from the read character “x”, it is determined that the right characters adjacent to the sequences that are the same as the sequence in the first pipeline are not characters of a same type. Therefore, it can be learned that the sequence “ab” included in the first pipeline is a maximal repeated sequence.

Further, the processor 1101 is further configured to:

destroy the first pipeline.

In general cases, when a maximal repeated sequence is acquired by using the foregoing apparatus, incremental mining can be implemented and a computation rate can be improved. However, the acquired maximal repeated sequence may include a relatively large quantity of redundant sub-sequences, and cannot effectively express a minimal unit of a sequence pattern, which does not help comprehension or analysis. For example, when maximal repeated sequence mining is performed on a sequence “#xyababpqababmn$”, “abab” may be used as a maximal repeated sequence thereof, while the sub-sequence “abab” includes two smaller identical sub-sequences “ab” that are concatenated. Therefore, to make a mined sequence be a maximal non-concatenated repeated sequence, further, the processor 1101 is further configured to:

in the pipeline set, if there exists such a second pipeline that after the character is appended to the second pipeline, a sequence in the second pipeline is the same as a corresponding sequence on the suffix tree, append the character to the second pipeline, and point a location pointer of the second pipeline to a location, on the suffix tree, of a tail character of the sequence included in the second pipeline appended with the character; and

determine a maximal non-concatenated repeated sequence according to the location pointer of the second pipeline and a second preset policy.

Further, the processor 1101 is specifically configured to:

determine whether the location pointer of the second pipeline is the same as a location pointer of a reference pipeline of the second pipeline, where the reference pipeline of the second pipeline is a pipeline that is in the pipeline set and that includes a sequence whose initial character is the same as an initial character of the sequence included in the second pipeline when the initial character of the sequence included in the second pipeline is read; and

if the location pointer of the second pipeline is the same as the location pointer of the reference pipeline of the second pipeline, determine that the sequence in the second pipeline is the maximal non-concatenated repeated sequence.

For example, an initial character of the sequence included in the second pipeline is “a”, and when “a” is read (that is, when the second pipeline is still an empty pipeline), each pipeline in the pipeline set is traversed; it is found that an initial character included in #4 pipeline is also “a”, and at this time, the location pointer of #4 pipeline is <r→4→2, 1>. In this case, #4 pipeline is determined as the reference pipeline of the second pipeline, and the location pointer <r→4→2, 1> is determined as a reference pointer of the second pipeline. In a process of continuously appending new characters to the second pipeline, if the location pointer of the second pipeline reaches <r→4→2, 1>, a sequence included in the second pipeline when the location pointer of the second pipeline is <r→4→2, 1> is determined as a maximal non-concatenated repeated sequence.

Further, the processor 1101 is further configured to:

establish an empty pipeline before the character is read;

traverse an initial character of each branch of the suffix tree; if an initial character the same as the character exists, store the character into the empty pipeline, and point a location pointer of the empty pipeline to a location, on the suffix tree, of the initial character the same as the character; and in the pipeline set, if there exists such a third pipeline that after the character is appended to the third pipeline, a sequence in the third pipeline is different from a corresponding sequence on the suffix tree, split, starting from a location to which a location pointer of the third pipeline points, a corresponding branch on the suffix tree into two branches, and insert the character into each branch on the suffix tree after splitting; or if there exists such a third pipeline that after the character is appended to the third pipeline, a sequence in the third pipeline is the same as a corresponding sequence on the suffix tree, insert the character into each branch on the suffix tree; or

if an initial character the same as the character does not exist, destroy the empty pipeline, and split a new branch from a root node of the suffix tree; and in the pipeline set, if there exists such a third pipeline that after the character is appended to the third pipeline, a sequence in the third pipeline is different from a corresponding sequence on the suffix tree, split, starting from a location to which a location pointer of the third pipeline points, a corresponding branch on the suffix tree into two branches, and insert the character into each branch of the suffix tree after splitting; or if there exists such a third pipeline that after the character is appended to the third pipeline, a sequence in the third pipeline is the same as a corresponding sequence on the suffix tree, insert the character into each branch of the suffix tree after splitting.

Further, to conveniently and quickly use acquired pattern information to perform analysis in subsequent work, the processor 1101 is further configured to:

store related information of the determined maximal repeated sequence and related information of the determined maximal non-concatenated repeated sequence into a preset pattern information table, and express, on the suffix tree, the related information of the maximal repeated sequence and the related information of the maximal non-concatenated repeated sequence, where the related information includes: a sequence number, sequence content, and a sequence length.

The expressing, on the suffix tree, the related information of the maximal non-concatenated repeated sequence is: separately expressing, on a corresponding branch of the suffix tree, a pattern number of a sequence pattern and a remaining length, on the current branch, of the sequence pattern that corresponds to the pattern number.

For example, assuming that 1000 pieces of pattern information have been found and now comparison needs to be performed for a sequence “ab” currently being identified, in this case, if the whole information table is searched, comparison needs to be performed 1000 times from the beginning to the end of the table. However, if the pattern information is stored on the suffix tree according to a storage rule of the suffix tree, only patterns on a branch “ab” need to be involved in comparison, and if there are 10 pieces of pattern information on the branch “ab”, only the 10 pieces of pattern information need to be involved in comparison, which increases a comparison speed and facilitates retrieval.

The expressing, on the suffix tree, the related information of the maximal repeated sequence and the related information of the maximal non-concatenated repeated sequence is:

separately expressing, on a corresponding branch of the suffix tree, a pattern number of a sequence pattern and a remaining length of the sequence pattern that corresponds to the pattern number.

For example, related information of the determined maximal non-concatenated repeated sequences “ab” and “b” is stored in a preset pattern information table 1, and as show in FIG. 5, corresponding to table 1, related information of mined sequence patterns is expressed on a suffix, where a character stored on a branch r→8 of the suffix tree is “a”, which is initial characters of sequences corresponding to a pattern number 1 and a pattern number 2 in the pattern information table, and in this case, related information [1,2] about the pattern number 1 and a length of the sequence corresponding to the pattern number 1, and related information [2,1] about the pattern number 2 and a length of the sequence corresponding to the pattern number 2 are stored on the branch Searching is performed downward along the branch r→8, related information [1,1] about the pattern number 1 and a remaining length 1 of the sequence corresponding to the pattern number 1 is stored on a branch 8→4 corresponding to a remaining character of the sequence corresponding to the pattern number 1.

It can be learned from the above that, this embodiment of the present invention provides an apparatus 110 for mining a maximal repeated sequence, where a character is acquired; the character is appended to each pipeline in a pipeline set, and it is separately determined whether a sequence in each pipeline appended with the character is the same as a corresponding sequence on a suffix tree, where the pipeline set includes at least one pipeline, the pipeline includes a sequence and a location pointer, the sequence includes a character the same as a character that is in a character string in which the character is located and that is in front of the character, and the location pointer points to a location, on the suffix tree, of a tail character of the sequence included in the pipeline; and in the pipeline set, if there exists such a first pipeline that after the character is appended to the first pipeline, a sequence in the first pipeline is different from a corresponding sequence on the suffix tree, a maximal repeated sequence is determined according to a first preset policy and the sequence in the first pipeline. In this way, a maximal repeated sequence is mined by means of a combination of a pipeline structure and a suffix tree structure, which improves a computation rate. Besides, in the pipeline set, if there exists such a second pipeline that after the character is appended to the second pipeline, a sequence in the second pipeline is the same as a corresponding sequence on the suffix tree, the character is appended to the second pipeline, and a location pointer of the second pipeline is pointed to a location, on the suffix tree, of a tail character of the sequence included in the second pipeline appended with the character; and a maximal non-concatenated repeated sequence is determined according to the location pointer of the second pipeline and a second preset policy, so that the mined maximal repeated sequence is a non-concatenated repeated sequence, which avoids problems in the prior art that incremental mining cannot be implemented, a computation amount is large, and a mined maximal repeated sequence includes a redundant concatenated structure and cannot effectively express a minimal unit of a sequence pattern.

In the several embodiments provided in this application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The units described as separate parts may or may not be physically separate, and parts displayed as units may or may not be physical units, may be located in one location, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, or a network device) to perform some of the steps of the methods described in the embodiments of the present invention. The foregoing storage medium includes: any medium that can store program code, such as a USB flash drive, a removable hard disk, a read-only memory (Read-Only Memory, ROM), a random access memory (Random Access Memory, RAN), a magnetic disk, or an optical disc.

Finally, it should be noted that the foregoing embodiments are merely intended for describing the technical solutions of the present invention but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

What is claimed is:

1. A method for mining a maximal repeated sequence, the method comprising:
acquiring a character;
appending the character to each pipeline in a pipeline set, and separately determining whether a sequence in each pipeline appended with the character is the same as a corresponding sequence on a suffix tree, wherein the pipeline set comprises at least one pipeline, the pipeline comprises a sequence and a location pointer, the sequence comprises a character the same as a character that is in a character string in which the acquired character is located and that is in front of the acquired character, and the location pointer points to a location, on the suffix tree, of a tail character of the sequence comprised in the pipeline; and
determining a maximal repeated sequence according to a first preset policy and the sequence in the first pipeline, when there exists such a first pipeline in the pipeline set that after the character is appended to the first pipeline, a sequence in the first pipeline is different from a corresponding sequence on the suffix tree.

2. The method according to claim 1, wherein determining the maximal repeated sequence according to the first preset policy and the sequence in the first pipeline comprises:
detecting, in the character string, whether left characters adjacent to sequences that are the same as the sequence in the first pipeline are characters of a same type, and detecting whether right characters adjacent to the sequences that are the same as the sequence in the first pipeline are characters of a same type; and
determining that the sequence in the first pipeline is the maximal repeated sub-sequence, when the left characters adjacent to the sequences that are the same as the sequence in the first pipeline are not characters of a same type, and the right characters adjacent to the sequences that are the same as the sequence in the first pipeline are not characters of a same type; or
determining that the sequence in the first pipeline is not the maximal repeated sequence, and destroying the first pipeline when the left characters adjacent to the sequences that are the same as the sequence in the first pipeline are characters of a same type, or the right characters adjacent to the sequences that are the same as the sequence in the first pipeline are characters of a same type, or the left characters adjacent to the sequences that are the same as the sequence in the first pipeline are characters of a same type and the right characters adjacent to the sequences that are the same as the sequence in the first pipeline are characters of a same type.

3. The method according to claim 2, wherein detecting, in the character string, whether left characters adjacent to sequences that are the same as the sequence in the first pipeline are characters of the same type, and detecting whether right characters adjacent to the sequences that are the same as the sequence in the first pipeline are characters of the same type comprises:
acquiring, in the character string, a set of left characters adjacent to the sequences that are the same as the sequence in the first pipeline;
determining that the left characters adjacent to the sequences that are the same as the sequence in the first pipeline are characters of a same type when the character set comprises characters of a same type; or
determining that the left characters adjacent to the sequences that are the same as the sequence in the first pipeline are not characters of a same type when the character set comprises at least two types of characters; and
on the suffix tree:
determining whether a character to which a location pointer of the first pipeline points is the same as the character,
determining that the right characters adjacent to the sequences that are the same as the sequence in the first pipeline are characters of a same type when the character to which the location pointer of the first pipeline points is the same as the character, or
determining that the right characters adjacent to the sequences that are the same as the sequence in the first pipeline are not characters of a same type when the character to which the location pointer of the first pipeline points is different from the character.

4. The method according to claim 1, wherein separately determining whether the sequence in each pipeline appended with the character is the same as the corresponding sequence on the suffix tree comprises:
on the suffix tree:
separately moving the location pointer in each pipeline, so that the location pointer points to a location of a next character adjacent to the tail character of the sequence comprised in the pipeline; and
determining whether the character to which the moved location pointer points is the same as the character;
determining that the sequence in the pipeline appended with the character is different from the corresponding sequence on the suffix tree when the character to which the moved location pointer points is different from the character; or
determining that the sequence in the pipeline appended with the character is the same as the corresponding sequence on the suffix tree when the character to which the moved location pointer points is the same as the character.

5. The method according to claim 1, further comprising:
appending the character to a second pipeline, and pointing a location pointer of the second pipeline to a location, on the suffix tree, of a tail character of the sequence comprised in the second pipeline appended with the character, when there exists such a second pipeline in the pipeline set that after the character is appended to the second pipeline, a sequence in the second pipeline is the same as a corresponding sequence on the suffix tree; and
determining a maximal non-concatenated repeated sequence according to the location pointer of the second pipeline and a second preset policy.

6. The method according to claim 5, wherein determining the maximal non-concatenated repeated sequence according to the location pointer of the second pipeline and the second preset policy comprises:
determining whether the location pointer of the second pipeline is the same as a location pointer of a reference pipeline of the second pipeline, wherein the reference pipeline of the second pipeline is a pipeline that is in the pipeline set and that comprises a sequence whose initial character is the same as an initial character of the sequence comprised in the second pipeline when the initial character of the sequence comprised in the second pipeline is read; and
determining that the sequence in the second pipeline is the maximal non-concatenated repeated sequence, when the location pointer of the second pipeline is the same as the location pointer of the reference pipeline of the second pipeline.

7. The method according to claim 6, further comprising:
determining that the sequence in the reference pipeline of the second pipeline is a concatenated sequence that comprises the sequence in the second pipeline; and
destroying the second pipeline and the reference pipeline of the second pipeline.

8. The method according to claim 1, wherein before the character is read, an empty pipeline is established; and
correspondingly, the method further comprises:
traversing an initial character of each branch of the suffix tree;
storing the character into the empty pipeline, and pointing a location pointer of the empty pipeline to a location, on the suffix tree, of the initial character the same as the character when an initial character the same as the character exists; and
splitting, starting from a location to which a location pointer of a third pipeline points, a corresponding branch on the suffix tree into two branches, and inserting the character into each branch on the suffix tree after splitting, when there exists such a third pipeline in the pipeline set that after the character is appended to the third pipeline, a sequence in the third pipeline is different from a corresponding sequence on the suffix tree; or
inserting the character into each branch on the suffix tree when there exists such a third pipeline that after the character is appended to the third pipeline, a sequence in the third pipeline is the same as a corresponding sequence on the suffix tree; or
destroying the empty pipeline, and splitting a new branch from a root node of the suffix tree when an initial character the same as the character does not exist; and
splitting, starting from a location to which a location pointer of the third pipeline points, a corresponding branch on the suffix tree into two branches, and inserting the character into each branch of the suffix tree after splitting, in the pipeline set, when there exists such a third pipeline that after the character is appended to the third pipeline, a sequence in the third pipeline is different from a corresponding sequence on the suffix tree; or
inserting the character into each branch of the suffix tree after splitting when there exists such a third pipeline that after the character is appended to the third pipeline, a sequence in the third pipeline is the same as a corresponding sequence on the suffix tree.

9. The method according to claim 1, further comprising:
storing related information of the determined maximal repeated sequence and related information of the determined maximal non-concatenated repeated sequence into a preset pattern information table; and
expressing, on the suffix tree, the related information of the maximal repeated sequence and the related information of the maximal non-concatenated repeated sequence, wherein the related information comprises: a sequence number, sequence content, and a sequence length.

10. An apparatus for mining a maximal repeated sequence, comprising:
an acquiring module, configured to acquire a character;
a judging module, configured to append the character acquired by the acquiring module to each pipeline in a pipeline set, and separately determine whether a sequence in each pipeline appended with the character is the same as a corresponding sequence on a suffix tree, wherein the pipeline set comprises at least one pipeline, the pipeline comprises a sequence and a location pointer, the sequence comprises a character the same as a character that is in a character string in which the acquired character is located and that is in front of the acquired character, and the location pointer points to a location, on the suffix tree, of a tail character of the sequence comprised in the pipeline; and
a first determining module, configured to:
determine a maximal repeated sequence according to a first preset policy and the sequence in the first pipeline, when there exists such a first pipeline in the pipeline set that after the character is appended to the first pipeline, a sequence in the first pipeline is different from a corresponding sequence on the suffix tree.

11. The apparatus according to claim 10, wherein the first determining module is configured to:
detect, in the character string, whether left characters adjacent to sequences that are the same as the sequence in the first pipeline are characters of a same type, and detect whether right characters adjacent to the sequences that are the same as the sequence in the first pipeline are characters of a same type; and
determine that the sequence in the first pipeline is the maximal repeated sub-sequence when the left characters adjacent to the sequences that are the same as the sequence in the first pipeline are not characters of a same type, and the right characters adjacent to the sequences that are the same as the sequence in the first pipeline are not characters of a same type; or
determine that the sequence in the first pipeline is not the maximal repeated sequence, and destroy the first pipeline when the left characters adjacent to the sequences that are the same as the sequence in the first pipeline are characters of a same type, or the right characters adjacent to the sequences that are the same as the sequence in the first pipeline are characters of a same type, or the left characters adjacent to the sequences that are the same as the sequence in the first pipeline are characters of a same type and the right characters adjacent to the sequences that are the same as the sequence in the first pipeline are characters of a same type.

12. The apparatus according to claim 11, wherein the first determining module is configured to:
acquire, in the character string, a set of left characters adjacent to the sequences that are the same as the sequence in the first pipeline;
determine that the left characters adjacent to the sequences that are the same as the sequence in the first pipeline are characters of a same type when the character set comprises characters of a same type; or determine that the left characters adjacent to the sequences that are the same as the sequence in the first pipeline are not characters of a same type when the character set comprises at least two types of characters; and
on the suffix tree:
determine whether a character to which a location pointer of the first pipeline points is the same as the character,
determine that the right characters adjacent to the sequences that are the same as the sequence in the first pipeline are characters of a same type when the character to which the location pointer of the first pipeline points is the same as the character, or
determine that the right characters adjacent to the sequences that are the same as the sequence in the first pipeline are not characters of a same type when the character to which the location pointer of the first pipeline points is different from the character.

13. The apparatus according to claim 10, wherein the judging module is configured to:
on the suffix tree:
separately move the location pointer in each pipeline, so that the location pointer points to a location of a next character adjacent to the tail character of the sequence comprised in the pipeline; and
determine whether the character to which the moved location pointer points is the same as the character;
determine that the sequence in the pipeline appended with the character is different from the corresponding sequence on the suffix tree when the character to which the moved location pointer points is different from the character; or
determine that the sequence in the pipeline appended with the character is the same as the corresponding sequence on the suffix tree when the character to which the moved location pointer points is the same as the character.

14. The apparatus according to claim 10, wherein the apparatus further comprises:
an appending module, configured to append the character to the second pipeline, and point a location pointer of the second pipeline to a location, on the suffix tree, of a tail character of the sequence comprised in the second pipeline appended with the character, when there exists such a second pipeline in the pipeline set that after the character is appended to the second pipeline, a sequence in the second pipeline is the same as a corresponding sequence on the suffix tree; and
a second determining module, configured to determine a maximal non-concatenated repeated sequence according to the location pointer of the second pipeline and a second preset policy.

15. The apparatus according to claim 14, wherein the second determining module is configured to:
determine whether the location pointer of the second pipeline is the same as a location pointer of a reference pipeline of the second pipeline, wherein the reference pipeline of the second pipeline is a pipeline that is in the pipeline set and that comprises a sequence whose initial character is the same as an initial character of the sequence comprised in the second pipeline when the initial character of the sequence comprised in the second pipeline is read; and
determine that the sequence in the second pipeline is the maximal non-concatenated repeated sequence when the location pointer of the second pipeline is the same as the location pointer of the reference pipeline of the second pipeline.

16. The apparatus according to claim 15, wherein the apparatus further comprises:
a destruction module, configured to:
determine that the sequence in the reference pipeline of the second pipeline is a concatenated sequence that comprises the sequence in the second pipeline; and
destroy the second pipeline and the reference pipeline of the second pipeline.

17. The apparatus according to claim 10, wherein the apparatus further comprises:
an establishment module, configured to:
establish an empty pipeline before the acquiring module acquires the character;
a search module, configured to:
traverse an initial character of each branch of the suffix tree; and
a storage module, configured to:
store the character into the empty pipeline, and point a location pointer of the empty pipeline to a location, on the suffix tree, of the initial character the same as the character when an initial character the same as the character exists; and
split, starting from a location to which a location pointer of a third pipeline points, a corresponding branch on the suffix tree into two branches, and insert the character into each branch on the suffix tree after splitting when there exists such a third pipeline in the pipeline set that after the character is appended to the third pipeline, a sequence in the third pipeline is different from a corresponding sequence on the suffix tree; or
insert the character into each branch on the suffix tree when there exists such a third pipeline that after the character is appended to the third pipeline, a sequence in the third pipeline is the same as a corresponding sequence on the suffix tree; or
destroy the empty pipeline, and split a new branch from a root node of the suffix tree; and
in the pipeline set when an initial character the same as the character does not exist, split, starting from a location to which a location pointer of the third pipeline points, a corresponding branch on the suffix tree into two branches, and insert the character into each branch of the suffix tree after splitting when there exists such a third pipeline that after the character is appended to the third pipeline, a sequence in the third pipeline is different from a corresponding sequence on the suffix tree; or
insert the character into each branch of the suffix tree after splitting when there exists such a third pipeline that after the character is appended to the third pipeline, a sequence in the third pipeline is the same as a corresponding sequence on the suffix tree.

18. The apparatus according to claim 10, wherein the apparatus further comprises:
a pattern information storage module, configured to:
store related information of the determined maximal repeated sequence and related information of the determined maximal non-concatenated repeated sequence into a preset pattern information table, and express, on the suffix tree, the related information of the maximal repeated sequence and the related information of the maximal non-concatenated repeated sequence, wherein the related information comprises: a sequence number, sequence content, and a sequence length.
